(19) United States
(12) Patent Application Publication
(10) Pub. No.: US 2011/0176741 A1
(43) Pub. Date: Jul. 21, 2011

(54) IMAGE PROCESSING APPARATUS AND IMAGE PROCESSING METHOD

(76) Inventors: Kazushi Sato, Kanagawa (JP); Yoichi Yagasaki, Tokyo (JP)

(21) Appl. No.: 13/119,719

(22) PCT Filed: Sep. 24, 2009
(86) PCT No.: PCT/JP2009/066489

§ 371 Date: Mar. 17, 2011

(30) Foreign Application Priority Data
Sep. 24, 2008 (JP) 2008-243958

(51) Int. Cl. G06K 9/36

(52) U.S. Cl. 382/238

(57) ABSTRACT

The present invention relates to an image processing apparatus and an image processing method capable of performing weighted prediction on the basis of local characteristics of an image.

An inter-TP motion prediction/compensation unit 76 performs a matching process on a block of an image of a frame to be encoded using an inter-template matching method and performs implicit weighted prediction using a weighting coefficient computed from the pixel values of a template region for the matching. The weighting coefficient is computed by a weighting coefficient computing unit 77. The present invention is applicable to, for example, an image encoding apparatus that performs encoding using the H.264/AVC standard.

### TECHNICAL FIELD

The present invention relates to an image processing apparatus and an image processing method and, in particular, to an image processing apparatus and an image processing method capable of performing weighted prediction on the basis of the local characteristics of an image.

### BACKGROUND ART

In recent years, apparatuses that manipulate image information in a digital format and, at that time, in order to transfer and accumulate the information efficiently, compression-encode an image have been in widespread use. The apparatuses use the redundancy that is specific to image information and employ a method for compressing the image on the basis of orthogonal transform, such as discrete cosine transform, and motion compensation (e.g., the MPEG (Moving Picture Experts Group phase) standard).

In particular, MPEG2 (ISO/IEC 13818-2) is defined as a general-purpose image encoding method. MPEG2 is a standard defined for interlacing scanned images and progressive scanned images and for standard-definition images and high-definition images. MPEG2 is widely used for professional and consumer applications nowadays. By using a MPEG2 compression standard and assigning an amount of coding (a bit rate) of 4 to 8 Mbps to a standard resolution interlacing image of 720×480 pixels and an amount of coding of 18 to 22 Mbps to a high-definition interlacing image of 1920×1088 pixels, a high compression ratio and an excellent image quality can be realized.

MPEG2 is intended to provide high-resolution encoding that accommodates with broadcasting and, thus, MPEG2 does not support a coding method having an amount of coding lower than that of MPEG1, that is, a compression ratio higher than that of MPEG1. However, as cell phones are becoming more widely used, the need for such an encoding method is increasing. Accordingly, the MPEG4 coding method has been standardized. For example, the MPEG4 image coding method was approved as the international standard ISO/IEC 14496-2 in December, 1998.

In addition, in recent years, in order to encode an image for TV conferences, standardization of the standard called H.26L (ITU-T Q6/16 VCEG) has been progressing. In H.26L, a large amount of computation is required for encoding and decoding operations, as compared with existing coding standards, such as MPEG2 and MPEG4. However, it is known that H.26L can realize a higher coding efficiency. Furthermore, standardization called Joint Model of Enhanced-Compression Video Coding has been progressing as part of the activities of MPEG4. The Joint Model of Enhanced-Compression Video Coding is based on H.26L and includes functions that are not supported by H.26L and, thus, a higher coding efficiency can be realized. The Joint Model of Enhanced-Compression Video Coding was approved as an international standard in March, 2003, as H.264 and MPEG-4 Part 10 (Advanced Video Coding; Hereinafter, referred to as “AVC”).

In addition, in an encoding method, such as MPEG-2, a motion prediction/compensation process with ½-pixel accuracy using a linear interpolation process is performed. In contrast, in the AVC coding standard, a motion prediction/compensation process with ¼-pixel accuracy using a 6-tap FIR (Finite Impulse Response Filter) filter is performed. Accordingly, in the AVC coding standard, coding efficiency can be improved. However, an enormous number of motion vector information items are generated. Therefore, if the motion vector information items are directly encoded, the coding efficiency decreases. To solve this problem, in the AVC coding standard, a decrease in the motion vector coding information is realized using a predetermined method.

An example of such a method is generating predicted motion vector information regarding a motion compensation block to be encoded next using motion vector information regarding neighboring and previously encoded motion compensation blocks and a median operation.

However, even when such a method is applied, the ratio of the motion vector information to the image compression information is not too small. Accordingly, a technique for searching within a decoded image of a frame to be referenced (hereinafter referred to as a “reference image”) for a region of an image having the highest correlation with a template region, which is part of the decoded image and adjacent to a target block to be encoded next in a frame to be encoded (hereinafter referred to as a “target frame”) with a predetermined positional relationship, and performing prediction on the basis of the searched region and a predetermined positional relationship has been proposed (refer to, for example, NPL 1).

This technique is referred to as an “inter-template matching method”. In this technique, a decoded image is used for matching. Accordingly, by predetermining a search area, the same process can be performed in an encoding apparatus and a decoding apparatus. That is, by performing motion prediction using the inter-template matching method in even the decoding apparatus, motion vector information need not be included in the image compression information received from the encoding apparatus. Therefore, a decrease in the encoding efficiency can be prevented.

In addition, if, for example, a scene including a fade is encoded using the MPEG-2 coding standard, the coding efficiency decreases.

That is, as shown in FIG. 1, when motion compensation is performed for an image in which the luminance is decreased from a frame Y₁ to a frame X via a frame Y₀ due to, for example, a fade and if a motion compensation method is performed on the basis of the MPEG-2 coding standard, the variation in luminance between the frames cannot be processed. For example, when motion compensation for the frame X to be encoded is performed using the previously encoded frame Y₀, the difference in luminance between frame Y₀ and the frame X disadvantageously appears as noise (a prediction error). As a result, the coding efficiency decreases.

Accordingly, in order to prevent such a decrease in the coding efficiency, a motion compensation technique called “weighted prediction” is defined in the AVC standard.

In addition, for a P picture, a technique called “explicit weighted prediction” among weighted prediction techniques is available. When explicit weighted prediction is used, a predicted image Pred can be given by the following equation (1).

Pred=w₀×P(L0)+d₀ (1)

Note that in equation (1), P(L0) denotes a predicted image extracted from a List0 reference frame pointed by the motion vector information, and w₀ and d₀ denote a weighting coefficient and an offset value included in the image compression information, respectively.

Furthermore, for a B picture, implicit weighted prediction can be available in addition to explicit weighted prediction among the weighted prediction techniques. When implicit weighted prediction and explicit weighted prediction are used and if the two reference frames are denoted as an L0 reference frame and the L1 reference frame, the predicted image Pred can be computed using the following equation (2).

Pred=w₀×P(L0)+w₀×P(L1)+d₀ (2)

Note that in equation (2), P(L0) and P(L1) denote a predicted image extracted from a List0 reference frame and a predicted image extracted from a List1 reference frame, respectively. In addition, in equation (2), w₀ and w₁ denote the weighting coefficients included in the image compression information for explicit weighted prediction. d₀ denote an offset value included in the image compression information.

In contrast, for implicit weighted prediction, d₀=0. w₀ and w₁ denote the weighting coefficients computed using the following equations (3).

w₁=tb/td

w₀=1−w₁ (3)

Note that in equations (3), as shown in FIG. 2, tb denotes a time distance between the L0 reference frame and the target frame to be encoded. td denotes a time distance between the L0 reference frame and the L1 reference frame. However, in practice, in the AVC standard, since parameters corresponding to tb and td are not included in the image compression information, POC (Picture Order Count) is used in stead of tb or td.

### CITATION LIST

### Non Patent Literature

NPL 1: “Inter Frame Coding with Template Matching Averaging”, Y. Suzuki et al, ICIP2007

### SUMMARY OF INVENTION

### Technical Problem

However, the POCs are not necessarily the same distance on the time axis. If the weighting coefficient of implicit weighted prediction is computed on the basis of the POCs, the coding efficiency may be decreased.

In addition, in the AVC method, the same weighting coefficient and the same offset value are used in the same picture (slice) for explicit weighted prediction and implicit weighted prediction. However, the values are not always optimal for all of the blocks in the screen.

Accordingly, the present invention allows weighted prediction to be performed on the basis of the local characteristics of an image.

### Solution to Problem

According to an aspect of the present invention, an image processing apparatus includes matching means for performing a matching process on a block of an image of a frame to be decoded using an inter-template matching method and predicting means for performing weighted prediction using pixel values of a template of the matching process performed by the matching means.

The image of the frame can be a P picture, and the weighted prediction can be implicit weighted prediction.

The predicting means can perform weighted prediction using the weighting coefficient computed from the pixel values of the template.

The image processing apparatus can further include computing means for computing the weighting coefficient using the following equation:

w₀=Ave(B′)/Ave(B)

where Ave(B) denotes an average value of the pixel values of the template, Ave(B′) denotes an average value of pixel values of a reference template that is a region of an image of a reference frame used as a reference for the matching and that has the highest correlation with the template, and w₀ denotes the weighting coefficient. The predicting means can compute predicted pixel values of the block using the weighting coefficient w₀ and the following equation:

Pred(A)=w₀×Pix(A′)

where Pred(A) denotes the predicted pixel value of the block and Pix(A′) denotes a pixel value of the region of an image of the reference frame having the same positional relationship with the reference template as a positional relationship between the template and the block.

The computing means can approximate the weighting coefficient w₀ to a value in the form of X/(2ⁿ).

The predicting means can perform weighted prediction using an offset computed from the pixel values of the template.

The image processing apparatus can further include computing means for computing the offset using the following equation:

d₀=Ave(B)−Ave(B′)

where Ave(B) denotes an average value of the pixel values of the template, Ave(B′) denotes an average value of pixel values of a reference template that is a region of an image of a reference frame used as a reference for the matching and that has the highest correlation with the template, and d₀ denotes the offset. The predicting means can compute predicted pixel values of the block using the offset d₀ and the following equation:

Pred(A)=Pred(A′)+d₀

where Pred(A) denotes the predicted pixel value of the block and Pix(A′) denotes a predicted pixel value of the region of the image of the reference frame having the same positional relationship with the reference template as a positional relationship between the template and the block.

The predicting means can extract, from a header portion of a P picture representing the image of the frame, information indicting that implicit weighted prediction has been performed as weighted prediction when encoding was performed on the block.

The image processing apparatus can further include computing means for computing first and second weighting coefficients used for weighted prediction from the pixel values of the template. The computing means can compute the first and second weighting coefficients using the following equations:

w₀=|Ave_tmplt_{—}L1−Ave_tmplt_Cur|, and

w₁=|Ave_tmplt_{—}L0−Ave_tmplt_Cur|

where Ave_tmplt_Cur denotes an average value of the template, Ave_tmplt_L0 and Ave_tmplt_L1 denote average values of pixel values of a first reference plate and a second reference template that are regions of images of first and second reference frames used as a reference for the matching and that have the highest correlation with the template, respectively, and w₀ and w₁ denote the first and second weighting coefficients, respectively. The computing means can normalize the first weighting coefficient w₀ and the second weighting coefficient w₁ using the following equations:

w₀=w₀/(w₀+w₁), and

w₁=w₁/(w₀+w₁).

The predicting means can compute predicted pixel values of the block using the normalized first weighting coefficient w₀ and second weighting coefficient w₁ and the following equation:

Pred_Cur=w₀×Pix_{—}L0+w₁×Pix_{—}L1

where Pred_Cur denotes the predicted pixel value of the block and Pix_L0 and Pix_L1 denote a pixel value of a region of an image of the first reference frame having the same positional relationship with the first reference template as a positional relationship between the template and the block and a pixel value of a region of an image of the second reference frame having the same positional relationship with the second reference template as the positional relationship between the template and the block, respectively.

The computing means can approximate each of the first weighting coefficient w₀ and the second weighting coefficient w₁ to a value in the form of X/(2ⁿ).

According to a first aspect of the present invention, an image processing method for use in an image processing apparatus includes the steps of performing a matching process on a block of an image of a frame to be decoded using an inter-template matching method and performing weighted prediction using pixel values of a template of the matching process.

According to a second aspect of the present invention, an image processing apparatus includes matching means for performing a matching process on a block of an image of a frame to be decoded using an inter-template matching method and predicting means for performing weighted prediction using pixel values of a template of the matching process performed by the matching means.

The image of the frame can be a P picture, and the weighted prediction can be implicit weighted prediction.

The image processing apparatus further include inserting means for inserting information indicating that implicit weighted prediction has been performed as weighted prediction into a header portion of the P picture representing the image of the frame.

According to the second aspect of the present invention, an image processing method for use in an image processing apparatus includes the steps of performing a matching process on a block of an image of a frame to be decoded using an inter-template matching method and performing weighted prediction using pixel values of a template of the matching process.

According to the first aspect of the present invention, a matching process is performed on a block of an image of a frame to be decoded using an inter-template matching method, and weighted prediction is performed using pixel values of a template of the matching process.

According to the second aspect of the present invention, a matching process is performed on a block of an image of a frame to be encoded using an inter-template matching method, and weighted prediction is performed using pixel values of a template of the matching process.

### Advantageous Effects of Invention

According to the present invention, weighted prediction can be performed on the basis of the local characteristics of an image.

### BRIEF DESCRIPTION OF DRAWINGS

FIG. 1 illustrates encoding of a scene including a fade.

FIG. 2 illustrates tb and td.

FIG. 3 is a block diagram of the configuration of an image encoding apparatus according to an embodiment of the present invention.

FIG. 4 illustrates a variable block size motion prediction/compensation process.

FIG. 5 illustrates a motion prediction/compensation process with ¼-pixel accuracy.

FIG. 6 is a flowchart of an encoding process performed by the image encoding apparatus shown in FIG. 3.

FIG. 7 is a flowchart of a prediction process shown in FIG. 6.

FIG. 8 illustrates a processing procedure in the case of a 16×16-pixel intra prediction mode.

FIG. 9 illustrates types of 4×4-pixel intra prediction mode in terms of a luminance signal.

FIG. 10 illustrates types of 4×4-pixel intra prediction mode in terms of a luminance signal.

FIG. 11 illustrates the directions of 4×4-pixel intra prediction modes.

FIG. 12 illustrates 4×4-pixel intra prediction.

FIG. 13 illustrates encoding in the 4×4-pixel intra prediction mode in terms of a luminance signal.

FIG. 14 illustrates types of 16×16-pixel intra prediction mode in terms of a luminance signal.

FIG. 15 illustrates types of 16×16-pixel intra prediction mode in terms of a luminance signal.

FIG. 16 illustrates 16×16-pixel intra prediction.

FIG. 17 illustrates types of intra prediction mode in terms of a color difference signal.

FIG. 18 is a flowchart of an intra prediction process.

FIG. 19 is a flowchart of an inter motion prediction process.

FIG. 20 illustrates an example of a method for generating motion vector information.

FIG. 21 illustrates an inter-template matching method.

FIG. 22 illustrates the inter-template matching method for a B picture.

FIG. 23 illustrates an inter-template motion prediction process.

FIG. 24 is a block diagram illustrating the configuration of an image decoding apparatus according to an embodiment of the present invention.

FIG. 25 is a flowchart of a decoding process performed by the image decoding apparatus shown in FIG. 24.

FIG. 26 is a flowchart of a prediction process shown in FIG. 25.

FIG. 27 illustrates an example of an extended block size.

FIG. 28 is a block diagram of an example of the primary configuration of a television receiver according to the present invention.

FIG. 29 is a block diagram of an example of a primary configuration of a cell phone according to the present invention.

FIG. 30 is a block diagram of an example of the primary configuration of a hard disk recorder according to the present invention.

FIG. 31 is a block diagram of an example of the primary configuration of a camera according to the present invention.

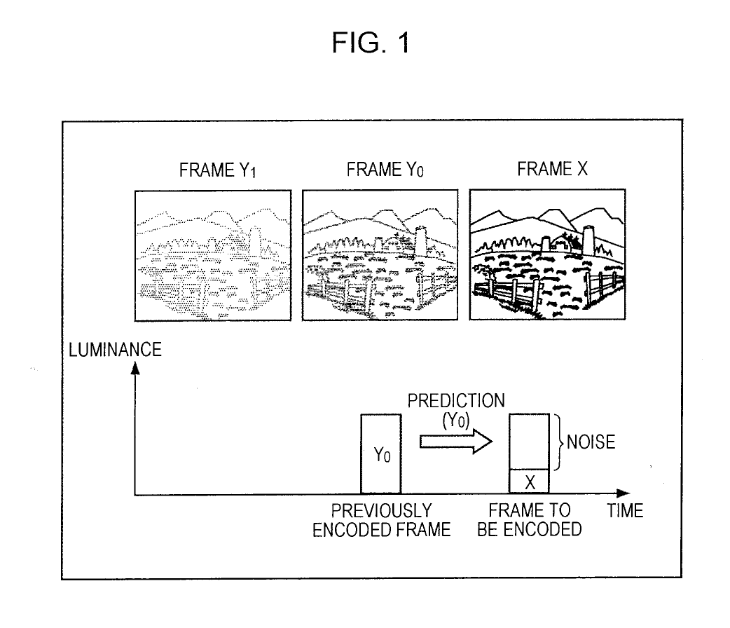

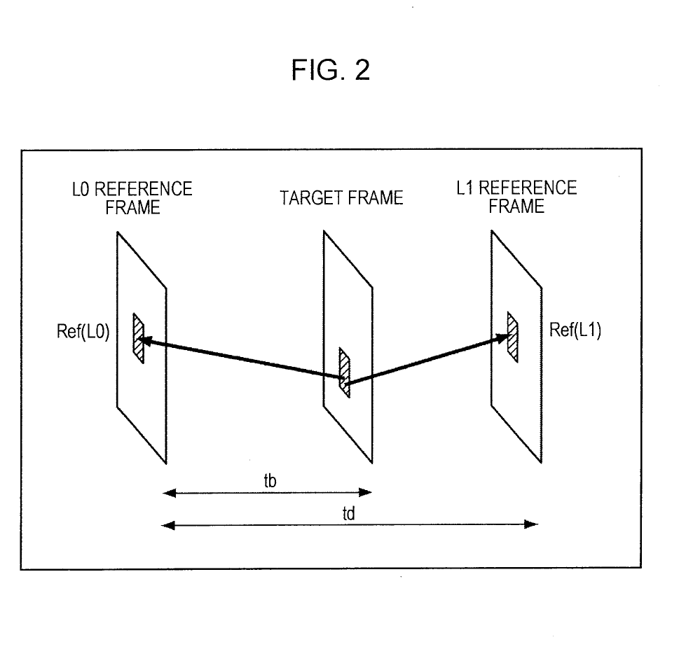

### DESCRIPTION OF EMBODIMENTS

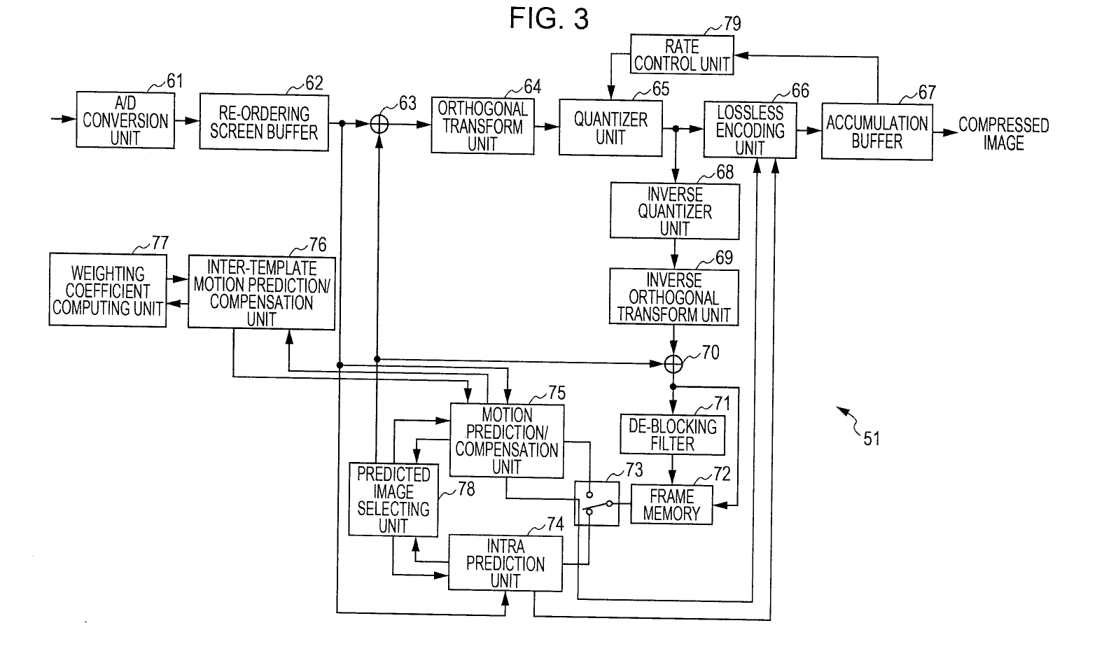

FIG. 3 illustrates the configuration of an image encoding apparatus according to an embodiment of the present invention. An image encoding apparatus 51 includes an A/D conversion unit 61, a re-ordering screen buffer 62, a computing unit 63, an orthogonal transform unit 64, a quantizer unit 65, a lossless encoding unit 66, an accumulation buffer 67, an inverse quantizer unit 68, an inverse orthogonal transform unit 69, a computing unit 70, a de-blocking filter 71, a frame memory 72, a switch 73, an intra prediction unit 74, a motion prediction/compensation unit 75, an inter-template motion prediction/compensation unit 76, a weighting coefficient computing unit 77, a predicted image selecting unit 78, and a rate control unit 79.

Hereinafter, the inter-template motion prediction/compensation unit 76 is referred to as an “inter-TP motion prediction/compensation unit 76”.

The image encoding apparatus 51 compression-encodes an image using, for example, the H.264 and AVC (hereinafter referred to as “H.264/AVC”) standard.

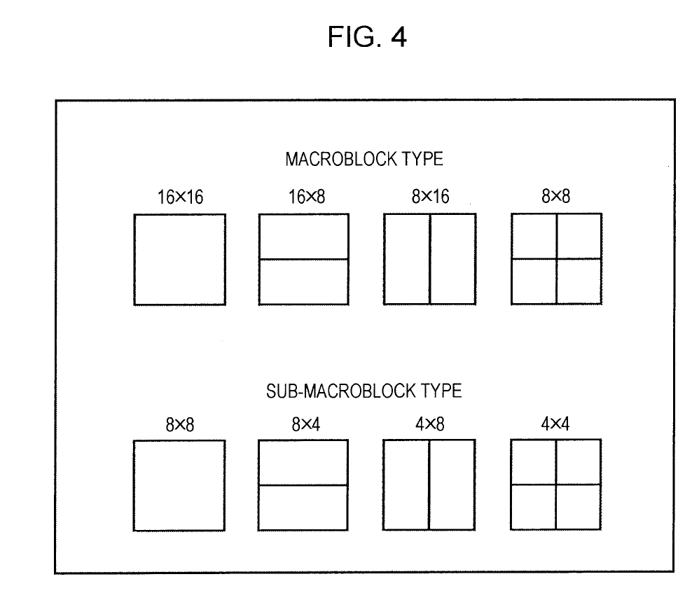

In the H.264/AVC standard, motion prediction/compensation is performed using a variable block size. That is, as shown in FIG. 4, in the H.264/AVC standard, a macroblock including 16×16 pixels is separated into one of 16×16 partitions, 16×8 partitions, 8×16 partitions, and 8×8 partitions. Each of the partitions can have independent motion vector information. In addition, as shown in FIG. 4, an 8×8 partition can be separated into one of 8×8 sub-partitions, 8×4 sub-partitions, 4×8 sub-partitions, and 4×4 sub-partitions. Each of the sub-partitions can have independent motion vector information.

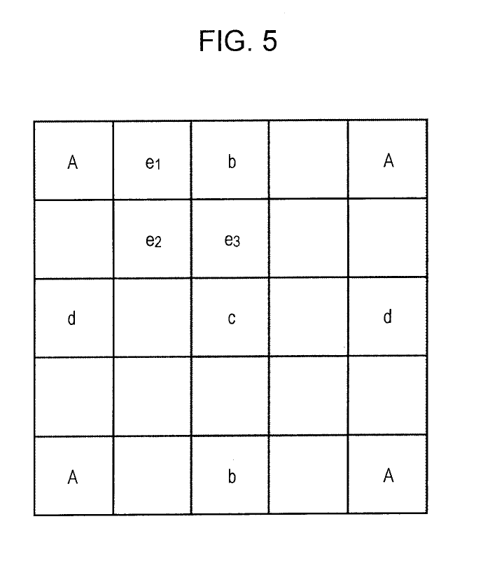

In addition, in the H.264/AVC standard, when a motion prediction and compensation process with ¼-pixel accuracy is performed using a 6-tap FIR filter. A prediction/compensation process with sub-pixel accuracy in the H.264/AVC standard is described next with reference to FIG. 5.

In an example shown in FIG. 5, positions A represent the positions of integer accuracy pixels, positions b, c, and d represent the positions of ½-pixel accuracy pixels, and positions e1, e2, and e3 represent the positions of ¼-pixel accuracy pixels. In the following description, Clip( ) is defined first as shown in the following equation (4).

$$\begin{matrix}[ Math . 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 4 )\end{matrix}$$

Note that when an input image is an image with 8-bit accuracy, the value of max_pix is 255.

The pixel values at the positions b and d are generated using a 6-tap FIR filter and the following equation (5).

[Math. 2]

F=A₋₂−5·A₋₁+20·A₀+20·A₁−5·A₂+A₃

b,d=Clip1((F+16)>>5) (5)

Note that in equation (5), Aₚ (p=−2, −1, 0, 1, 2, 3) denotes the pixel value at a position A remote from a position A corresponding to a position b or d by a distance p in the horizontal direction or the vertical direction. In addition, in equation (5), b and d denote the pixel values at the positions b and d, respectively.

Furthermore, the pixel value at a position c can be obtained using a 6-tap FIR filter in the horizontal direction and the vertical direction as follows.

[Math. 3]

F=b₋₂−5·b₋₁+20·b₀+20−b₁−5·b₂+b₃

or

F=d₋₂−5·d₋₁+20·d₀+20·d₁−5·d₂+d₃

c=Clip1((F+512)>>10) (6)

Note that in equation (6), bₚ and dₚ (p=−2, −1, 0, 1, 2, 3) denote the pixel values at the positions b and d remote from position b and d corresponding to the position c by a distance p in the horizontal direction or the vertical direction, respectively. In addition, c denotes the pixel values at the position c. In addition, in equation (6), after the computation for obtaining F in equation (6) is performed, that is, after a product-sum operation in the horizontal direction and a product-sum operation in the vertical direction are performed, the Clip process is finally performed only once.

In addition, the pixel values at the positions e₁ to e₃ are obtained using linear interpolation as follows:

[Math. 4]

e₁=(A+b+1)>>1

e₂=(b+d+1)>>1

e₃=(b+c+1)>>1 (7)

Note that in equation (7), A, a to d, and e₁ to e₃ denote the pixel values at the positions A, a to d, and e₁ to e₃, respectively.

Referring back to FIG. 3, the A/D conversion unit 61 A/D-converts an input image and outputs a converted image into the re-ordering screen buffer 62, which stores the converted image. Thereafter, the re-ordering screen buffer 62 re-orders, in accordance with the GOP (Group of Picture), the images of frames arranged in the order in which they are stored so that the images are arranged in the order in which the frames are to be encoded.

The computing unit 63 subtracts, from the image read from the re-ordering screen buffer 62, a predicted image that is received from the intra prediction unit 74 and that is selected by the predicted image selecting unit 78 or a predicted image that is received from the motion prediction/compensation unit 75. Thereafter, the computing unit 63 outputs the difference information to the orthogonal transform unit 64. The orthogonal transform unit 64 performs orthogonal transform, such as discrete cosine transform or Karhunen-Loeve transform, on the difference information received from the computing unit 63 and outputs the transform coefficient. The quantizer unit 65 quantizes the transform coefficient output from the orthogonal transform unit 64.

The quantized transform coefficient output from the quantizer unit 65 is input to the lossless encoding unit 66. Thereafter, a lossless encoding process, such variable-length coding (e.g., CAVLC (Context-based-Adaptive Variable Length Coding)) or an arithmetic coding (e.g., CABAC (Context-based-Adaptive Binary Arithmetic Coding)), is performed on the quantized transform coefficient. Thus, the transform coefficient is compressed. Note that, after accumulated in the accumulation buffer 67, the compressed image is output from the accumulation buffer 67.

In addition, the quantized transform coefficient output from the quantizer unit 65 is also input to the inverse quantizer unit 68 and is inverse-quantized. Thereafter, the transform coefficient is further subjected to inverse orthogonal transformation in the inverse orthogonal transducer unit 69. The result of the inverse orthogonal transformation is added to the predicted image supplied from the predicted image selecting unit 78 by the computing unit 70. In this way, a locally decoded image is generated. The de-blocking filter 71 removes block distortion of the decoded image and supplies the decoded image to the frame memory 72. Thus, the decoded image is accumulated. In addition, the image before the de-blocking filter process is performed by the de-blocking filter 71 is also supplied to the frame memory 72 and is accumulated.

The switch 73 outputs the image accumulated in the frame memory 72 to the motion prediction/compensation unit 75 or the intra prediction unit 74.

In the image encoding apparatus 51, for example, an I picture, a B picture, and a P picture received from the re-ordering screen buffer 62 are supplied to the intra prediction unit 74 as images to be subjected to intra prediction (also referred to as an “intra process”). In addition, a B picture and a P picture read from the re-ordering screen buffer 62 are supplied to the motion prediction/compensation unit 75 as images to be subjected to inter prediction (also referred to as an “inter process”).

The intra prediction unit 74 performs an intra prediction process in all of the candidate intra prediction modes using the image to be subjected to intra prediction and read from the re-ordering screen buffer 62 and a reference image supplied from the frame memory 72 via the switch 73. Thus, the intra prediction unit 74 generates a predicted image.

The intra prediction unit 74 computes a cost function value for each of the candidate intra prediction modes. The intra prediction unit 74 selects the intra prediction mode that minimizes the computed cost function value as an optimal intra prediction mode.

The intra prediction unit 74 supplies the predicted image generated in the optimal intra prediction mode and the cost function value of the optimal intra prediction mode to the predicted image selecting unit 78. When the predicted image generated in the optimal intra prediction mode is selected by the predicted image selecting unit 78, the intra prediction unit 74 supplies information regarding the optimal intra prediction mode to the lossless encoding unit 66. The lossless encoding unit 66 variable-length-encodes the information and uses the information as part of the header information.

The motion prediction/compensation unit 75 performs a motion prediction/compensation process for each of the candidate inter prediction modes. That is, the motion prediction/compensation unit 75 detects a motion vector in each of the candidate inter prediction modes on the basis of the image to be subjected to inter prediction and read from the re-ordering screen buffer 62 and the reference image supplied from the frame memory 72 via the switch 73. Thereafter, the motion prediction/compensation unit 75 performs a motion prediction/compensation process on the reference image on the basis of the motion vectors and generates a predicted image.

In addition, the motion prediction/compensation unit 75 supplies, to the inter-TP motion prediction/compensation unit 76, the image supplied from the frame memory 72 via the switch 73.

The motion prediction/compensation unit 75 computes a cost function value for each of the candidate inter prediction modes. The motion prediction/compensation unit 75 selects, as an optimal inter prediction mode, the prediction mode that minimizes the cost function value from among the cost function values computed for the inter prediction modes and the cost function values computed for the inter-template prediction modes by the inter-TP motion prediction/compensation unit 76.

The motion prediction/compensation unit 75 supplies the predicted image generated in the optimal inter prediction mode and the cost function value of the optimal inter prediction mode to the predicted image selecting unit 78. When the predicted image generated in the optimal inter prediction mode is selected by the predicted image selecting unit 78, the motion prediction/compensation unit 75 outputs, to the lossless encoding unit 66, information regarding the optimal inter prediction mode and information associated with the optimal inter prediction mode (e.g., the motion vector information, the reference frame information, and template method information (described in more detail below). The lossless encoding unit 66 also performs a lossless encoding process, such as a variable-length encoding process or an arithmetic coding process, on the information received from the motion prediction/compensation unit 75 and inserts the information into the header portion of the compressed image.

The inter-TP motion prediction/compensation unit 76 performs a motion prediction and compensation process in the inter-template prediction mode using an inter-template matching method or an inter-template weighted prediction method (described in more detail below) on the basis of the image supplied from the motion prediction/compensation unit 75. As a result, a predicted image is generated.

Note that the inter-template weighted prediction method is a method obtained by combining the inter-template matching method with weighted prediction. The weighting coefficient and the offset value used in weighted prediction among inter-template weighted prediction methods are supplied from the weighting coefficient computing unit 77. Note that there are two types of weighted prediction: explicit weighted prediction and implicit weighted prediction.

In addition, the inter-TP motion prediction/compensation unit 76 supplies, to the weighting coefficient computing unit 77, the image supplied from the motion prediction/compensation unit 75. Furthermore, the inter-TP motion prediction/compensation unit 76 computes a cost function value for the inter-template prediction mode and supplies the computed cost function value, the predicted image, and the template method information to the motion prediction/compensation unit 75.

Note that the template method information includes information indicating whether the inter-template weighted prediction method or the inter-template matching method is employed by the inter-TP motion prediction/compensation unit 76 as the motion prediction/compensation processing method. In addition, if the inter-template weighted prediction method is employed by the inter-TP motion prediction/compensation unit 76 as the motion prediction/compensation processing method, the template method information further includes information indicating whether implicit weighted prediction or explicit weighted prediction is employed as weighted prediction.

In addition, if explicit weighted prediction is employed as weighted prediction, the inter-TP motion prediction/compensation unit 76 supplies the weighting coefficient and the offset value used in the explicit weighted prediction to the motion prediction/compensation unit 75. If a predicted image generated using these weighting coefficient and offset value is selected by the predicted image selecting unit 78, the weighting coefficient and offset value are supplied to the lossless encoding unit 66. In the lossless encoding unit 66, the weighting coefficient and offset value are subjected to lossless encoding and are inserted into the header portion of the compressed image.

If explicit weighted prediction is employed as weighted prediction among inter-template weighted prediction methods, the weighting coefficient computing unit 77 determines the weighting coefficient and the offset value on a per picture basis for an image to be inter predicted by the inter-TP motion prediction/compensation unit 76. Thereafter, the weighting coefficient computing unit 77 supplies the determined weighting coefficient and offset value to the inter-TP motion prediction/compensation unit 76.

However, if implicit weighted prediction is employed as weighted prediction among inter-template weighted prediction methods, the weighting coefficient computing unit 77 computes the weighting coefficient or the offset value on a per inter-template matching block basis using the image supplied from the inter-TP motion prediction/compensation unit 76. Thereafter, the weighting coefficient computing unit 77 supplies the computed weighting coefficient or the offset value to the inter-TP motion prediction/compensation unit 76. Note that the process performed by the weighting coefficient computing unit 77 is described in more detail below.

The predicted image selecting unit 78 selects an optimal prediction mode from among the optimal intra prediction mode and the optimal inter prediction mode on the basis of the cost function values output from the intra prediction unit 74 or the motion prediction/compensation unit 75. Thereafter, the predicted image selecting unit 78 selects the predicted image in the selected optimal prediction mode and supplies the selected predicted image to the computing units 63 and 70. At that time, the predicted image selecting unit 78 supplies selection information regarding the predicted image to the intra prediction unit 74 or the motion prediction/compensation unit 75.

The rate control unit 79 controls the rate of the quantization operation performed by the quantizer unit 65 on the basis of the compressed images accumulated in the accumulation buffer 67 so that overflow and underflow does not occur.

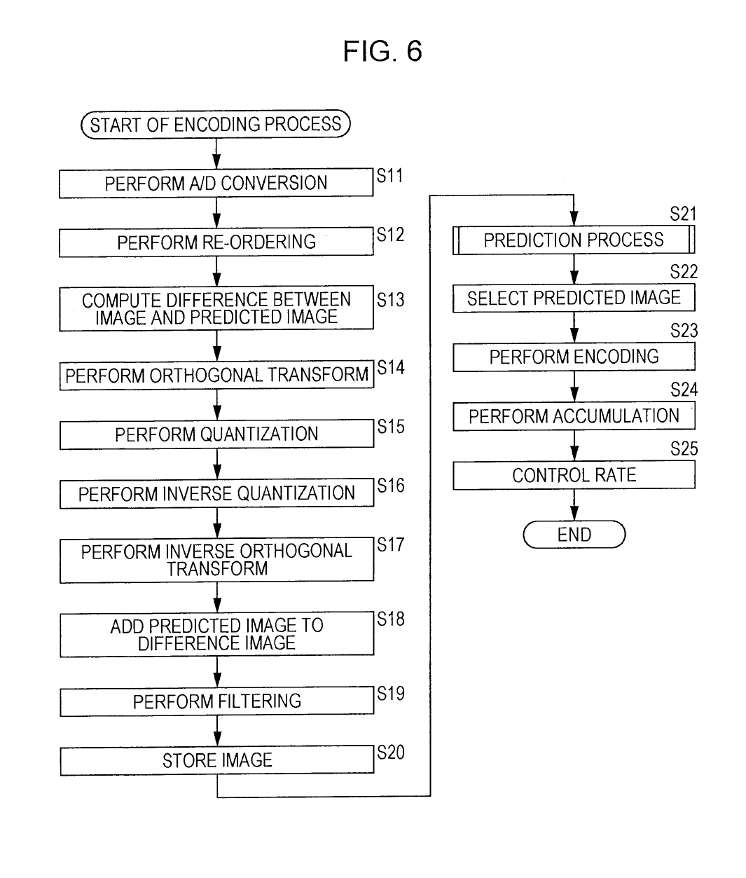

The encoding process performed by the image encoding apparatus 51 shown in FIG. 3 is described next with reference to a flowchart shown in FIG. 6.

In step S11, the A/D conversion unit 61 A/D-converts an input image. In step S12, the re-ordering screen buffer 62 stores the images supplied from the A/D conversion unit 61 and converts the order in which pictures are displayed into the order in which the pictures are to be encoded.

In step S13, the computing unit 63 computes the difference between the image re-ordered in step S12 and the predicted image. The predicted image is supplied from the motion prediction/compensation unit 75 in the case of inter prediction and is supplied from the intra prediction unit 74 in the case of intra prediction to the computing unit 63 via the predicted image selecting unit 78.

The data size of the difference data is smaller than that of the original image data. Accordingly, the data size can be reduced, as compared with the case in which the image is directly encoded.

In step S14, the orthogonal transform unit 64 performs orthogonal transform on the difference information supplied from the computing unit 63. More specifically, orthogonal transform, such as discrete cosine transform or Karhunen-Loeve transform, is performed, and a transform coefficient is output. In step S15, the quantizer unit 65 quantizes the transform coefficient. As described in more detail below with reference to a process performed in step S25, the rate is controlled in this quantization process.

The difference information quantized in the above-described manner is locally decoded as follows. That is, in step S16, the inverse quantizer unit 68 inverse quantizes the transform coefficient quantized by the quantizer unit 65 using a characteristic that is the reverse of the characteristic of the quantizer unit 65. In step S17, the inverse orthogonal transform unit 69 performs inverse orthogonal transform on the transform coefficient inverse quantized by the inverse quantizer unit 68 using the characteristic corresponding to the characteristic of the orthogonal transform unit 64.

In step S18, the computing unit 70 adds the predicted image input via the predicted image selecting unit 78 to the locally decoded difference information. Thus, the computing unit 70 generates a locally decoded image (an image corresponding to the input of the computing unit 63). In step S19, the de-blocking filter 71 performs filtering on the image output from the computing unit 70. In this way, block distortion is removed. In step S20, the frame memory 72 stores the filtered image. Note that the image that is not subjected to the filtering process performed by the de-blocking filter 71 is also supplied to the frame memory 72 and is stored in the frame memory 72.

In step S21, each of the intra prediction unit 74, the motion prediction/compensation unit 75, and the inter-TP motion prediction/compensation unit 76 performs its own image prediction process. That is, in step S21, the intra prediction unit 74 performs an intra prediction process in the intra prediction mode. The motion prediction/compensation unit 75 performs a motion prediction/compensation process in the inter prediction mode. In addition, the inter-TP motion prediction/compensation unit 76 performs a motion prediction/compensation process in the inter-template prediction mode.

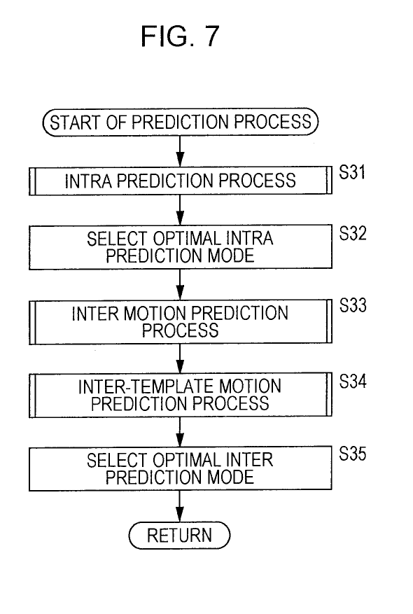

The prediction process performed in step S21 is described in more detail below with reference to FIG. 7. Through the prediction process performed in step S21, the prediction process in each of the candidate prediction modes is performed, and the cost function values for all of the candidate prediction modes are computed. Thereafter, the optimal intra prediction mode is selected on the basis of the computed cost function values, and a predicted image generated using intra prediction in the optimal intra prediction mode and the cost function value of the optimal intra prediction mode are supplied to the predicted image selecting unit 78. In addition, the optimal inter prediction mode is determined from among the inter prediction modes and the inter-template prediction modes using the computed cost function values. Thereafter, a predicted image generated in the optimal inter prediction mode and the cost function value of the optimal inter prediction mode are supplied to the predicted image selecting unit 78.

In step S22, the predicted image selecting unit 78 selects one of the optimal intra prediction mode and the optimal inter prediction mode as an optimal prediction mode using the cost function values output from the intra prediction unit 74 and the motion prediction/compensation unit 75. Thereafter, the predicted image selecting unit 78 selects the predicted image in the determined optimal prediction mode and supplies the predicted image to the computing units 63 and 70. As described above, this predicted image is used for the computation performed in steps S13 and S18.

Note that the selection information regarding the predicted image is supplied to the intra prediction unit 74 or the motion prediction/compensation unit 75. When the predicted image in the optimal intra prediction mode is selected, the intra prediction unit 74 supplies information regarding the optimal intra prediction mode to the lossless encoding unit 66.

When the predicted image in the optimal inter prediction mode is selected, the motion prediction/compensation unit 75 supplies information regarding the optimal inter prediction mode and information associated with the optimal inter prediction mode (e.g., the motion vector information, the reference frame information, the template method information, the weighting coefficient, and the offset value) to the lossless encoding unit 66.

That is, when the predicted image in the inter prediction mode is selected as that in the optimal inter prediction mode, the motion prediction/compensation unit 75 outputs information indicating the inter prediction mode (hereinafter referred to as “inter prediction mode information” as needed), the motion vector information, and the reference frame information to the lossless encoding unit 66.

In contrast, when the predicted image in the inter-template prediction mode is selected as that in the optimal inter prediction mode, the motion prediction/compensation unit 75 supplies information indicating the inter-template prediction mode (hereinafter referred to as “inter-template prediction mode information” as needed) and the template method information to the lossless encoding unit 66. Note that if explicit weighted prediction is employed as weighted prediction among the inter-template weighted prediction methods, the motion prediction/compensation unit 75 also outputs the weighting coefficient and the offset value to the lossless encoding unit 66.

In step S23, the lossless encoding unit 66 encodes the quantized transform coefficient output from the quantizer unit 65. That is, the difference image is lossless encoded (e.g., variable-length encoded or arithmetic encoded) and is compressed. At that time, the above-described information regarding the optimal intra prediction mode input from the intra prediction unit 74 to the lossless encoding unit 66 or the above-described information associated with the optimal inter prediction mode (e.g., the prediction mode information, the motion vector information, the reference frame information, the template method information, the weighting coefficient, and the offset value) input from the motion prediction/compensation unit 75 to the lossless encoding unit 66 in step S22 is also encoded and is added to the header information.

In step S24, the accumulation buffer 67 accumulates the compressed difference image as a compressed image. The compressed image accumulated in the accumulation buffer 67 is read out as needed and is transferred to the decoding side via a transmission line.

In step S25, the rate control unit 79 controls the rate of the quantization operation performed by the quantizer unit 65 on the basis of the compressed images stored in the accumulation buffer 67 so that overflow and underflow do not occur.

The prediction process performed in step S21 shown in FIG. 6 is described next with reference to a flowchart shown in FIG. 7.

If each of the images supplied from the re-ordering screen buffer 62 and to be processed is an image of a block to be intra processed, the decoded image to be referenced is read from the frame memory 72 and is supplied to the intra prediction unit 74 via the switch 73. In step S31, the intra prediction unit 74 performs, using these images, intra prediction on a pixel of the block to be processed in all of the candidate intra prediction modes. Note that the pixel that is not subjected to deblock filtering performed by the de-blocking filter 71 is used as the decoded pixel to be referenced.

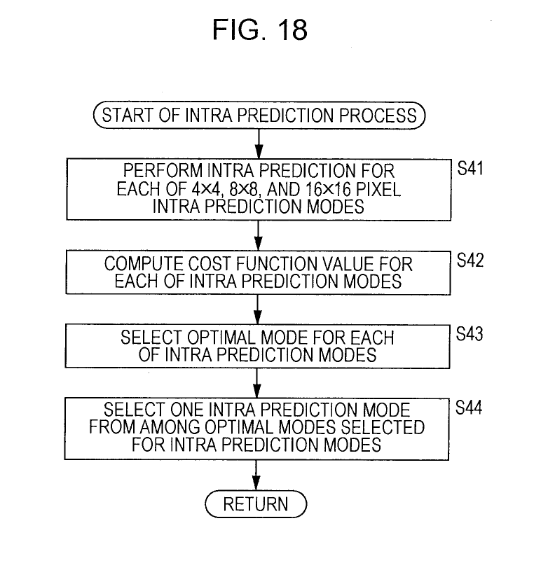

The intra prediction process performed in step S31 is described below with reference to FIG. 18. Through the intra prediction process, intra prediction is performed in all of the candidate intra prediction modes, and the cost function values for all of the candidate intra prediction modes are computed.

In step S32, the intra prediction unit 74 compares the cost function values for all of the candidate intra prediction modes computed in step S31 with one another. Thus, the prediction mode that provides the minimum cost function value is selected as an optimal intra prediction mode. Thereafter, the intra prediction unit 74 supplies a predicted image generated in the optimal intra prediction mode and the cost function value thereof to the predicted image selecting unit 78.

If the image supplied from the re-ordering screen buffer 62 and to be processed is an image to be subjected to the inter process, a decoded image to be referenced is read from the frame memory 72 and is supplied to the motion prediction/compensation unit 75 via the switch 73. In step S33, the motion prediction/compensation unit 75 performs an inter motion prediction process using these images. That is, the motion prediction/compensation unit 75 references the decoded image supplied from the frame memory 72 and performs a motion prediction process for all of the candidate inter prediction modes.

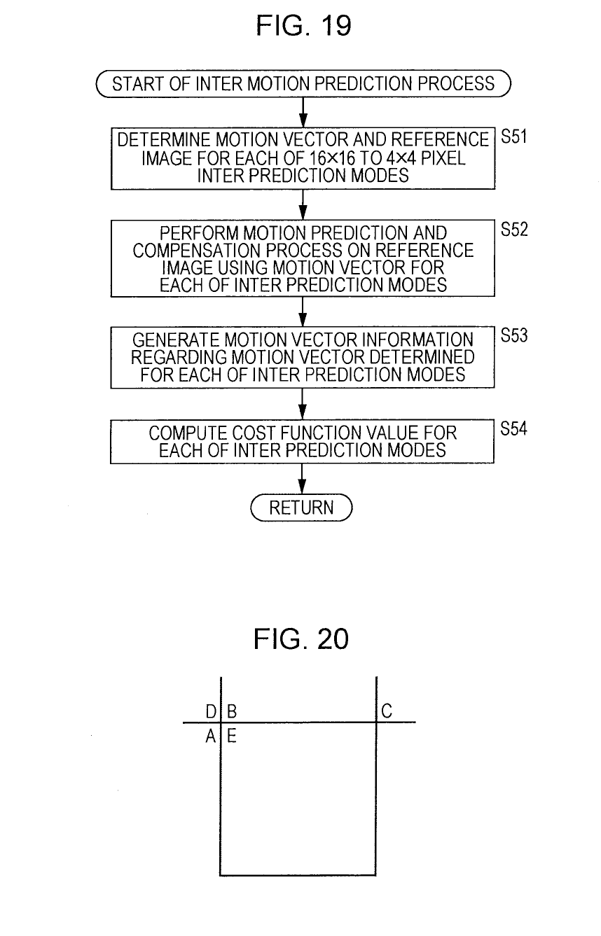

The inter motion prediction process performed in step S33 is described in more detail below with reference to FIG. 19. Through the inter motion prediction process, a motion prediction process is performed in all of the candidate inter prediction modes, and the cost function values for all of the candidate inter prediction modes are computed.

Furthermore, if the image supplied from the re-ordering screen buffer 62 and to be processed is an image to be subjected to the inter process, the decoded image to be referenced and read from the frame memory 72 is also supplied to the inter-TP motion prediction/compensation unit 76 via the switch 73 and the motion prediction/compensation unit 75. In step S34, the inter-TP motion prediction/compensation unit 76 and the weighting coefficient computing unit 77 perform an inter-template motion prediction process in the inter-template prediction mode using these images.

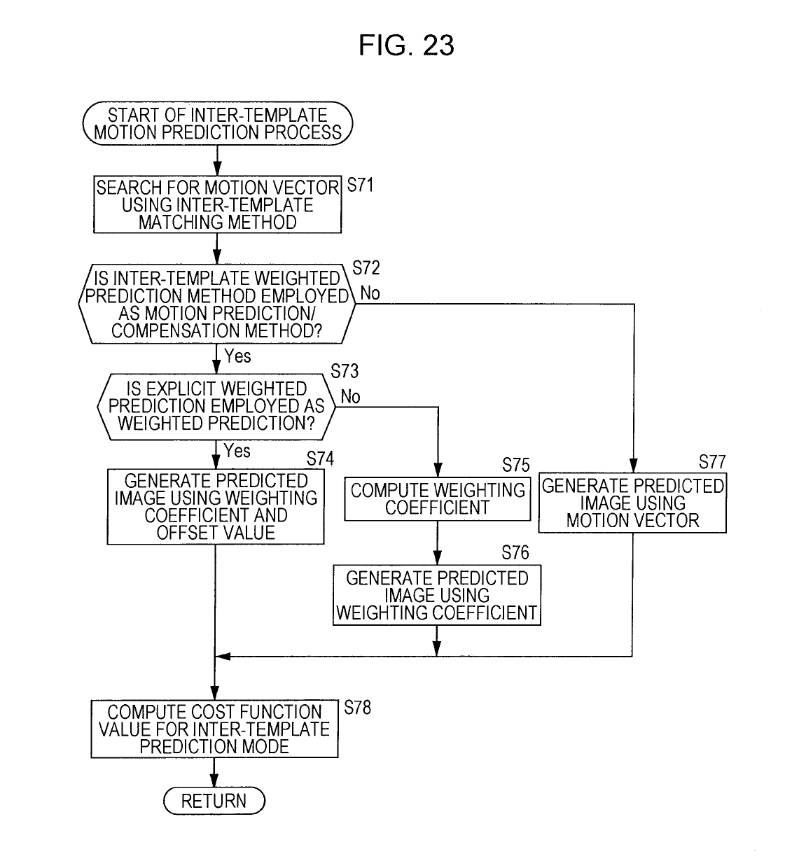

The inter-template motion prediction process performed in step S34 is described in more detail below with reference to FIG. 23. Through the inter-template motion prediction process, a motion prediction process in the inter-template prediction mode is performed, and a cost function value for the inter-template prediction mode is computed. Thereafter, a predicted image generated through the motion prediction process in the inter-template prediction mode and the cost function value thereof are supplied to the motion prediction/compensation unit 75.

In step S35, the motion prediction/compensation unit 75 compares the cost function value for the optimal inter prediction mode selected in step S33 with the cost function value for the inter-template prediction mode computed in step S34. Thus, the prediction mode that provides the minimum cost function value is selected as an optimal inter prediction mode. Thereafter, the motion prediction/compensation unit 75 supplies a predicted image generated in the optimal inter prediction mode and the cost function value thereof to the predicted image selecting unit 78.

Each of the intra prediction modes defined in the H.264/AVC standard is described next.

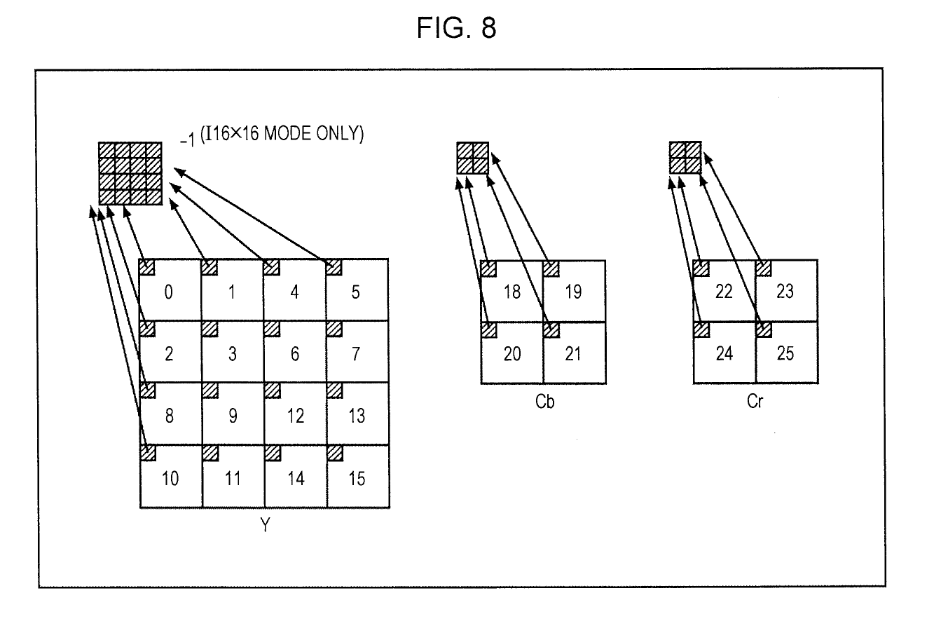

The intra prediction mode for a luminance signal is described first. The intra prediction mode for a luminance signal includes nine types of prediction mode on a per 4×4 pixel block basis and four types of prediction mode on a per 16×16 pixel macroblock basis. As shown in FIG. 8, in the case of 16×16 pixel intra prediction mode, a DC component of each block is collected and, therefore, a 4×4 matrix is generated. Furthermore, orthogonal transform is performed on the 4×4 matrix.

Note that in a high profile, a prediction mode on a per 8×8 pixel block basis is defined for an 8th-order DCT block. This method conforms to the 4×4 pixel intra prediction mode described below.

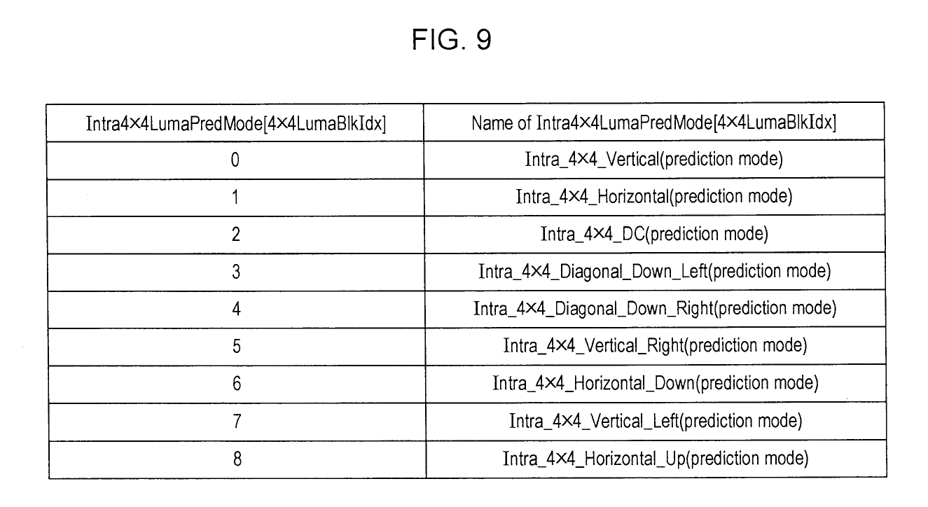

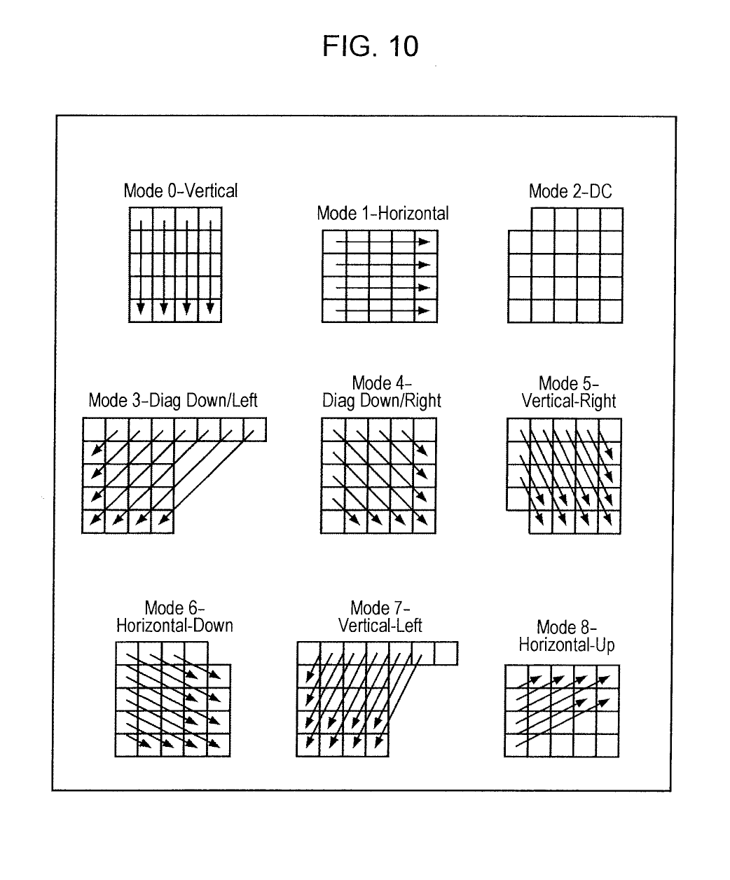

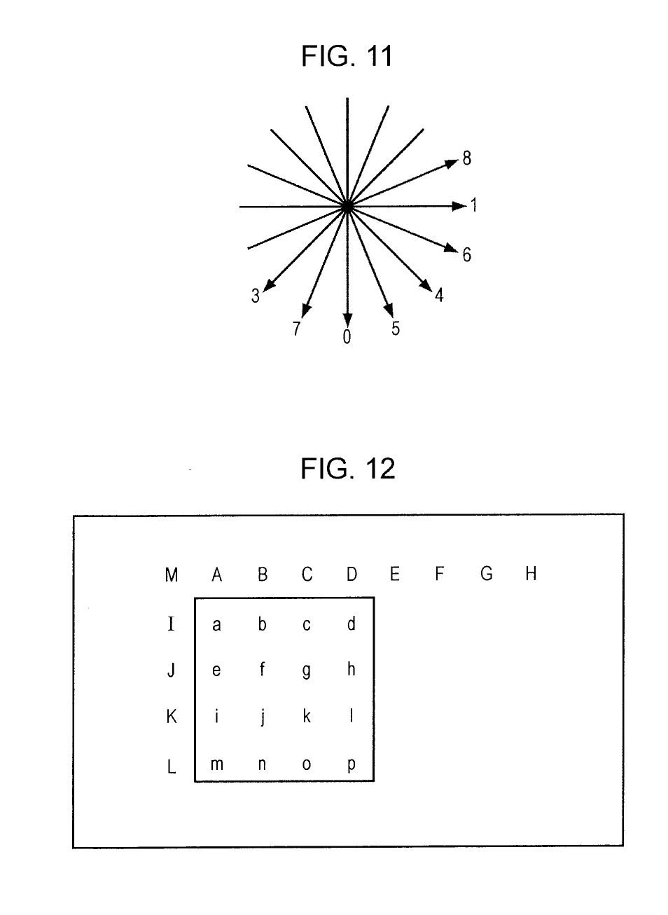

FIGS. 9 and 10 illustrate 9 types of the 4×4 pixel intra prediction mode (Intra_{—}4×4_pred_mode) of a luminance signal. Eight types of the mode other than Mode 2 indicating average value (DC) prediction correspond to the directions indicated by the numbers “0”, “1”, and “3” to “8” shown in FIG. 11.

The nine types of Intra_{—}4×4_pred_mode are described next with reference to FIG. 12. In the example shown in FIG. 12, pixels a to p represent pixels of a target block to be intra processed. Pixels A to M represent the pixel values of pixels of a neighboring block. That is, the pixels a to p are pixels to be processed and read from the re-ordering screen buffer 62. In contrast, the pixels A to M are the pixel values of pixels of a decoded image that is read from the frame memory 72 as a reference image and that has not yet been subjected to a process performed by the de-blocking filter.

In the case of each of the intra prediction modes shown in FIGS. 9 and 10, the predicted pixel values of the pixels a to p are generated using the pixel values A to M of the pixels of the neighboring block in a manner described below. Note that an “available” pixel value refers to a pixel value that is available because the pixel is not located at the end of an image frame or the pixel has already been encoded. In contrast, an “unavailable” pixel value refers to a pixel value that is not available because the pixel is located at the end of an image frame or the pixel has not yet been encoded.

Mode 0 indicates vertical prediction. Mode 0 is applied only when the pixel values A to D are “available”. In this case, the predicted pixel values of the pixels a to p are given by the following equation (8).

Predicted pixel value of the pixel a, e, i, m=A

Predicted pixel value of the pixel b, f, n=B

Predicted pixel value of the pixel c, g, k, o=C

Predicted pixel value of the pixel d, h, l, p=D (8)

Mode 1 indicates horizontal prediction. Mode 1 is applied only when the pixel values I to L are “available”. In this case, the predicted pixel values of the pixels a to p are given by the following equation (9).

Predicted pixel value of the pixel a, b, c, d=I

Predicted pixel value of the pixel e, f, g, h=J

Predicted pixel value of the pixel i, j, k, l=K

Predicted pixel value of the pixel m, n, o, p=L (9)

Mode 2 indicates DC prediction. When all of the pixel values A, B, C, D, I, J, K, and L are “available”, the predicted pixel value is given by the following expression (10).

(A+B+C+D+i+J+K+L+4)>>3 (10)

In addition, when all of the pixel values A, B, C, and D are “unavailable”, the predicted pixel value is given by the following expression (11).

(I+J+K+L+2)>>2 (11)

In addition, when all of the pixel values I, J, K, and L are “unavailable”, the predicted pixel value is given by the following expression (12).

(A+B+C+D+2)>>2 (12)

Note that when all of the pixel values A, B, C, D, I, J, K, and L are “unavailable”, the predicted pixel value is set to 128.

Mode 3 indicates Diagonal_Down_Left Prediction. Mode 3 is applied only when all of the pixel values A, B, C, D, I, J, K, L, and M are “available”. In this case, the predicted pixel values of the pixels a to p are given by the following equation (13).

Predicted pixel value of the pixel a=(A+2B+C+2)>>2

Predicted pixel value of the pixel b, e=(B+2C+D+2)>>2

Predicted pixel value of the pixel c, f, i=(C+2D+E+2)>>2

Predicted pixel value of the pixel d, g, j, m=(D+2E+F+2)>>2

Predicted pixel value of the pixel h, k, n=(E+2F+G+2)>>2

Predicted pixel value of the pixel l, o=(F+2G+H+2)>>2

Predicted pixel value of the pixel p=(G+3H+2)>>2 (13)

Mode 4 indicates Diagonal_Down_Right Prediction. Mode 4 is applied only when the pixel values A, B, C, D, I, J, K, L, and M are “available”. In this case, the predicted pixel values of the pixels a to p are given by the following equation (14).

Predicted pixel value of the pixel m=(J+2K+L+2)>>2

Predicted pixel value of the pixel i, n=(I+2J+K+2)>>2

Predicted pixel value of the pixel e, j, o=(M+2I+J+2)>>2

Predicted pixel value of the pixel a, f, k, p=(A+2M+I+2)>>2

Predicted pixel value of the pixel b, g, l=(M+2A+B+2)>>2

Predicted pixel value of the pixel c, h=(A+2B+C+2)>>2

Predicted pixel value of the pixel d=(B+2C+D+2)>>2 (14)

Mode 5 indicates Diagonal_Vertical_Right Prediction. Mode 5 is applied only when the pixel values A, B, C, D, I, J, K, L, and M are “available”. In this case, the predicted pixel values of the pixels a to p are given by the following equation (15).

Predicted pixel value of the pixel a, j=(M+A+1)>>1

Predicted pixel value of the pixel b, k=(A+B+1)>>1

Predicted pixel value of the pixel c, l=(B+C+1)>>1

Predicted pixel value of the pixel d=(C+D+1)>>1

Predicted pixel value of the pixel e, n=(I+2M+A+2)>>2

Predicted pixel value of the pixel f, o=(M+2A+B+2)>>2

Predicted pixel value of the pixel g, p=(A+2B+C+2)>>2

Predicted pixel value of the pixel h=(B+2C+D+2)>>2

Predicted pixel value of the pixel i=(M+2I+J+2)>>2

Predicted pixel value of the pixel m=(I+2J+K+2)>>2 (15)

Mode 6 indicates Horizontal_Down Prediction. Mode 6 is applied only when the pixel values A, B, C, D, I, J, K, L, and M are “available”. In this case, the predicted pixel values of the pixels a to p are given by the following equation (16).

Predicted pixel value of the pixel a, g=(M+I+1)>>1

Predicted pixel value of the pixel b, h=(I+2M+A+2)>>2

Predicted pixel value of the pixel c=(M+2A+B+2)>>2

Predicted pixel value of the pixel d=(A+2B+C+2)>>2

Predicted pixel value of the pixel e, k=(I+J+1)>>1

Predicted pixel value of the pixel f, l=(M+2I+J+2)>>2

Predicted pixel value of the pixel i, o=(J+K+1)>>1

Predicted pixel value of the pixel j, p=(I+2J+K+2)>>2

Predicted pixel value of the pixel m=(K+L+1)>>1

Predicted pixel value of the pixel n=(J+2K+L+2)>>2 (16)

Mode 7 indicates Vertical Left Prediction. Mode 7 is applied only when the pixel values A, B, C, D, I, J, K, L, and M are “available”. In this case, the predicted pixel values of the pixels a to p are given by the following equation (17).

Predicted pixel value of the pixel a=(A+B+1)>>1

Predicted pixel value of the pixel b, i=(B+C+1)>>1

Predicted pixel value of the pixel c, j=(C+D+1)>>1

Predicted pixel value of the pixel d, k=(D+E+1)>>1

Predicted pixel value of the pixel l=(E+F+1)>>1

Predicted pixel value of the pixel e=(A+2B+C+2)>>2

Predicted pixel value of the pixel f, m=(B+2C+D+2)>>2

Predicted pixel value of the pixel g, n=(C+2D+E+2)>>2

Predicted pixel value of the pixel h, o=(D+2E+F+2)>>2

Predicted pixel value of the pixel p=(E+2F+G+2)>>2 (17)

Mode 8 indicates Horizontal_Up Prediction. Mode 8 is applied only when the pixel values A, B, C, D, I, J, K, L, and M are “available”. In this case, the predicted pixel values of the pixels a to p are given by the following equation (18).

Predicted pixel value of the pixel a=(I+J+1)>>1

Predicted pixel value of the pixel b=(I+2J+K+2)>>2

Predicted pixel value of the pixel c, e=(J+K+1)>>1

Predicted pixel value of the pixel d, f=(J+2K+L+2)>>2

Predicted pixel value of the pixel g, i=(K+L+1)>>1

Predicted pixel value of the pixel h, j=(K+3L+2)>>2

Predicted pixel value of the pixel k, l, m, n, o, p=L (18)

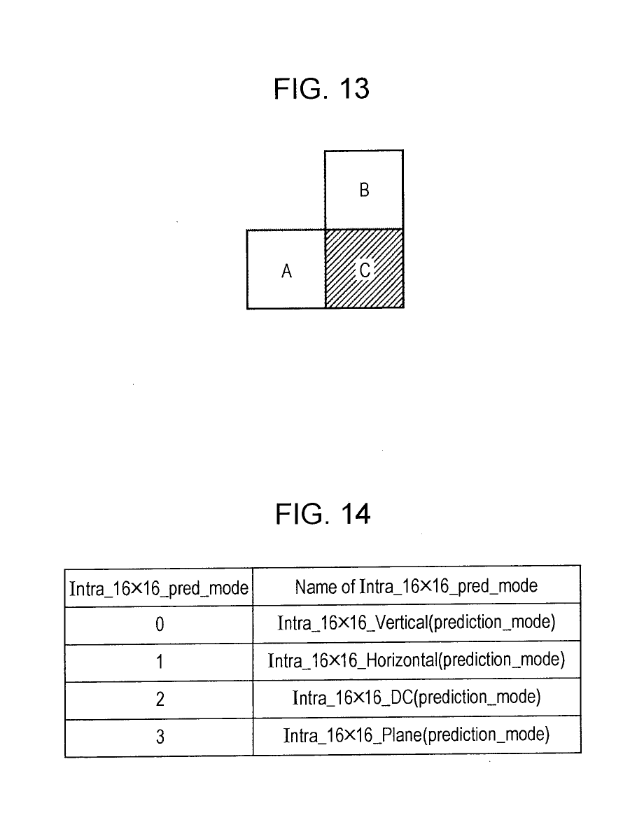

A coding method in the 4×4 pixel intra prediction mode (Intra_{—}4×4_pred_mode) of a luminance signal is described next with reference to FIG. 13.

In the example shown in FIG. 13, a 4×4 pixel target block C to be encoded is shown. In addition, 4×4 pixel blocks A and B that are adjacent to the target block C are shown.

In this case, Intra_{—}4×4_pred_mode for the target block C and Intra_{—}4×4_pred_mode for the blocks A and B are highly correlated. By performing the following encoding process using such a high correlation, a higher coding efficiency can be realized.

That is, in the example shown in FIG. 13, let Intra_{—}4×4_pred_modeA and Intra_{—}4×4_pred_modeB denote Intra_{—}4×4_pred_modes for the blocks A and B, respectively. Then, MostProbableMode is defined as shown in the following equation (19).

MostProbableMode=Min(Intra_{—}4×4_pred_modeA, Intra_{—}4×4_pred_modeB) (19)

That is, one of the blocks A and B that is assigned a smaller mode number is defined as MostProbableMode.

In a bit stream, two values: prev_intra4×4_pred_mode_flag[luma4×4BlkIdx] and rem_intra4×4_pred_mode[luma4×4BlkIdx] are defined as parameters for the target block C. Through the process based on the following pseudo code indicated by expression (20), a decoding process is performed. Thus, the values of Intra_{—}4×4_pred_mode and Intra4×4 PredMode[luma4×4BlkIdx] can be obtained.

if (prev_intra4×4_pred_mode_flag[luma4×4BlkIdx]) Intra4×4 PredMode[luma4×4BlkIdx]=MostProbableMode

else

if (rem_intra4×4_pred_mode[luma4×4BlkIdx]<MostProbableMode)

Intra4×4 PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (20)

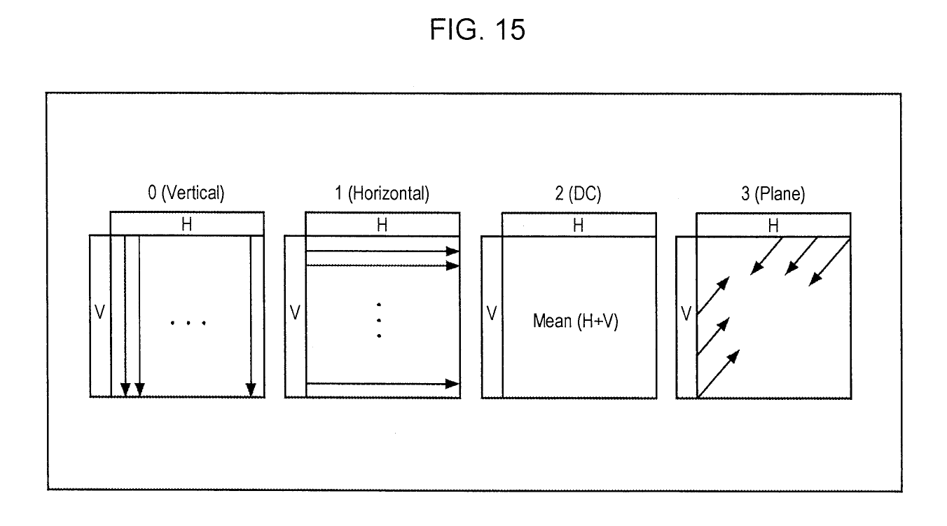

The 16×16-pixel intra prediction mode is described next. FIGS. 14 and 15 illustrate four types of 16×16-pixel intra prediction mode (Intra_{—}16×16_pred_mode) of a luminance signal.

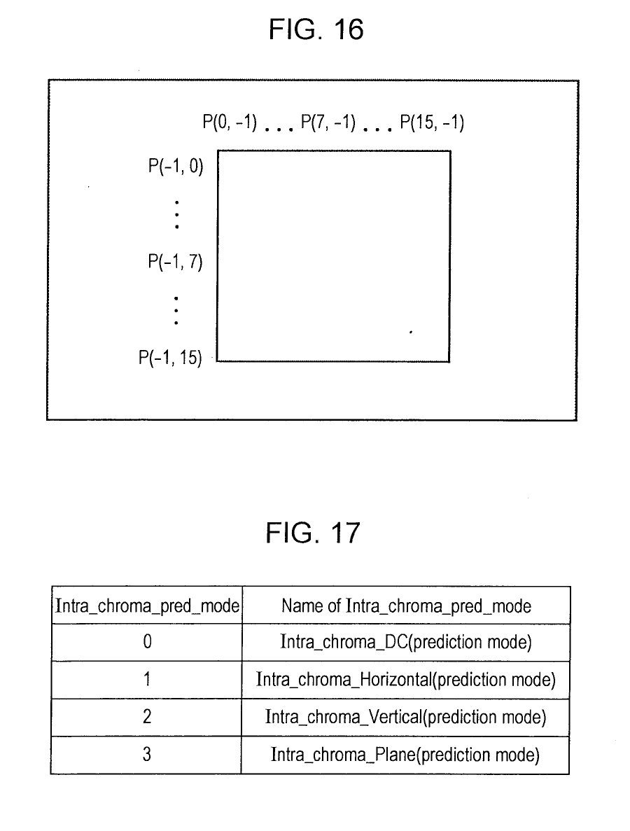

The four types of 16×16-pixel intra prediction mode are described next with reference to FIG. 16. In the example shown in FIG. 16, a target macroblock A to be intra processed is shown. P(x, y); x, y=−1, 0, . . . , 15 represents the pixel value of a pixel that is adjacent to the target macroblock A.

Mode 0 indicates Vertical Prediction. Mode 0 is applied only when P(x, −1); x, y=−1, 0, . . . , 15 is “available”. In this case, the predicted pixel value Pred(x, y) of each of the pixels of the target macroblock A is generated using the following equation (21).

Pred(x,y)=P(x,−1); x,y=0, . . . , 15 (21)

Mode 1 indicates Horizontal Prediction. Mode 1 is applied only when P(−1, y); x, y=−1, 0, . . . , 15 is “available”. In this case, the predicted pixel value Pred(x, y) of each of the pixels of the target macroblock A is generated using the following equation (22).

Pred(x,y)=P(x,−1); x,y=0, . . . , 15 (22)

Mode 2 indicates DC Prediction. Mode 2 is applied only when all of P(x, −1) and P(−1, y); x, y=1, 0, . . . , 15 are “available”. In this case, the predicted pixel value Pred(x, y) of each of the pixels of the target macroblock A is generated using the following equation (23).

$$\begin{matrix}[ Math . 5 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with \\ x , y = 0 , … , 15 & ( 23 )\end{matrix}$$

However, when P(x, −1); x, y=−1, 0, . . . , 15 is “unavailable”, the predicted pixel value Pred(x, y) of each of the pixels of the target macroblock A is generated using the following equation (24).

$$\begin{matrix}[ Math . 6 ] & \\ Pred ( x , y ) = [ {\sum }_{{y}^{′} = 0}^{15} P ( - 1 , {y}^{′} ) + 8 ] >> 4 \\ with \\ x , y = 0 , … , 15 & ( 24 )\end{matrix}$$

If P(−1, y); x, y=−1, 0, . . . , 15 is “unavailable”, the predicted pixel value Pred(x, y) of each of the pixels of the target macroblock A is generated using the following equation (25).

$$\begin{matrix}[ Math . 7 ] & \\ Pred ( x , y ) = [ {\sum }_{{y}^{′} = 0}^{15} P ( {x}^{′} , - 1 ) + 8 ] >> 4 \\ with \\ x , y = 0 , … , 15 & ( 25 )\end{matrix}$$

If all of P(x, −1) and P(−1, y); x, y=−1, 0, . . . , 15 are “unavailable”, the predicted pixel value is set to 128.

Mode 3 indicates Plane Prediction. Mode 3 is applied only when all of P(x, −1) and P(−1, y); x, y=−1, 0, . . . , 15 are “available”. In this case, the predicted pixel value Pred(x, y) of each of the pixels of the target macroblock A is generated using the following equation (26).

$$\begin{matrix}[ Math . 8 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 26 )\end{matrix}$$

The intra prediction mode for a color difference signal is described next. FIG. 17 illustrates four types of intra prediction mode (Intra_chroma_pred_mode) for a color difference signal. The intra prediction mode for a color difference signal can be set independently from the intra prediction mode of a luminance signal. The intra prediction mode for a color difference signal is substantially the same as the above-described 16×16-pixel intra prediction mode for a luminance signal.

However, while the above-described 16×16 pixel intra prediction mode for a luminance signal is applied to a 16×16 pixel block, the intra prediction mode for a color difference signal is applied to an 8×8 pixel block. In addition, as indicated by FIGS. 14 and 17, the mode numbers of the two modes do not correspond to each other.

Like the above-described definitions of the pixel value of the target macroblock A and the pixel value of the neighboring pixel in the 16×16 pixel intra prediction mode of a luminance signal illustrated in FIG. 16, the pixel value of a pixel adjacent to the target macroblock A (8×8 pixels for a color difference signal) to be intra processed is defined as P(x, y); x, y=−1, 0, . . . , 7.

Mode 0 indicates DC Prediction. Mode 0 is applied only when all of P(x, −1) and P(−1, y); x, y=−1, 0, . . . , 7 are “available”. In this case, the predicted pixel value Pred(x, y) of each of the pixels of the target macroblock A is generated using the following equation (27).

$$\begin{matrix}[ Math . 9 ] & \\ Pred ( x , y ) = ( ( {\sum }_{n = 0}^{7} ( P ( - 1 , n ) + P ( n , - 1 ) ) ) + 8 ) >> 4 \\ with \\ x , y = 0 , … , 7 & ( 27 )\end{matrix}$$

However, if P(−1, y); x, y=−1, 0, . . . , 7 is “unavailable”, the predicted pixel value Pred(x, y) of each of the pixels of the target macroblock A is generated using the following equation (28).

$$\begin{matrix}[ Math . 10 ] & \\ Pred ( x , y ) = [ ( {\sum }_{n = 0}^{7} P ( n , - 1 ) ) + 4 ] >> 3 \\ with \\ x , y = 0 , … , 7 & ( 28 )\end{matrix}$$

Alternatively, if P(x, −1); x, y=−1, 0, . . . , 7 is “unavailable”, the predicted pixel value Pred(x, y) of each of the pixels of the target macroblock A is generated using the following equation (29).

$$\begin{matrix}[ Math . 11 ] & \\ Pred ( x , y ) = [ ( {\sum }_{n = 0}^{7} P ( - 1 , n ) ) + 4 ] >> 3 \\ with \\ x , y = 0 , … , 7 & ( 29 )\end{matrix}$$

Mode 1 indicates Horizontal Prediction. Mode 1 is applied only when P(−1, y); x, y=−1, 0, . . . , 7 is “available”. In this case, the predicted pixel value Pred(x, y) of each of the pixels of the target macroblock A is generated using the following equation (30).

Pred(x,y)=P(−1,y); x,y=0, . . . , 7 (30)

Mode 2 indicates Vertical Prediction. Mode 2 is applied only when P(x, −1); x, y=−1, 0, . . . , 7 is “available”. In this case, the predicted pixel value Pred(x, y) of each of the pixels of the target macroblock A is generated using the following equation (31).

Pred(x,y)=P(x,−1); x,y=0, . . . , 7 (31)

Mode 3 indicates Plane Prediction. Mode 3 is applied only when P(x, −1) and P(−1, y); x, y=−1, 0, . . . , 7 are “available”. In this case, the predicted pixel value Pred(x, y) of each of the pixels of the target macroblock A is generated using the following equation (32).

$$\begin{matrix}[ Math . 12 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 32 )\end{matrix}$$

As described above, the intra prediction mode for a luminance signal includes nine types of prediction mode on a per 4×4 pixel block basis and on a per 8×8 pixel block basis and four types of prediction mode on a per 16×16 pixel macroblock basis. The intra prediction mode for a color difference signal includes four types of prediction mode on a per 8×8 pixel block basis. The intra prediction mode for a color difference signal can be set independently from the intra prediction mode for a luminance signal. For 4×4 pixel and 8×8 pixel intra prediction modes for a luminance signal, an intra prediction mode is defined for each of 4×4 pixel and 8×8 pixel blocks of a luminance signal. For the 16×16 pixel intra prediction mode for a luminance signal and the intra prediction mode for a color difference signal, a prediction mode is defined for one macroblock.

Note that the types of prediction mode correspond to the directions indicated by the numbers “0”, “1”, and “3” to “8” shown in FIG. 11. The prediction mode 2 represents average value prediction.

The intra prediction process performed for these intra prediction modes in step S31 shown in FIG. 7 is described next with reference to a flowchart shown in FIG. 18. Note that an example illustrated in FIG. 18 is described with reference to a luminance signal.

In step S41, the intra prediction unit 74 performs intra prediction for each of the above-described 4×4-pixel, 8×8-pixel, and 16×16-pixel intra prediction modes.

For example, a 4×4 pixel intra prediction mode is described next with reference to FIG. 12 described above. When an image to be processed and read from the re-ordering screen buffer 62 (e.g., pixels a to p) is the image of a block to be intra processed, a decoded image to be referenced (the pixels indicated by pixel values A to M) is read from the frame memory 72. Thereafter, the readout image is supplied to the intra prediction unit 74 via the switch 73.

The intra prediction unit 74 performs intra prediction on the pixels of the block to be processed using these images. Such an intra prediction process is performed for each of the intra prediction modes and, therefore, a predicted image for each of the intra prediction modes is generated. Note that pixels that are not subjected to deblock filtering performed by the de-blocking filter 71 are used as the decoded pixels to be referenced (the pixels indicated by pixel values A to M).

In step S42, the intra prediction unit 74 computes the cost function value for each of 4×4 pixel, 8×8 pixel, and 16×16 pixel intra prediction modes. At that time, the computation of the cost function values is performed using one of the techniques of a High Complexity mode and a Low Complexity mode as defined in the JM (Joint Model), which is H.264/AVC reference software.

That is, in the High Complexity mode, the processes up to the encoding process are performed for all of the candidate prediction modes as a process performed in step S41. Thus, a cost function value defined by the following equation (33) is computed for each of the prediction modes and, thereafter, the prediction mode that provides a minimum cost function value is selected as an optimal prediction mode.

Cost(Mode)=D+λ·R (33)

D denotes the difference (distortion) between the original image and the decoded image, R denotes an amount of generated code including up to the orthogonal transform coefficient, and λ denotes the Lagrange multiplier in the form of a function of a quantization parameter QP.

In contrast, in the Low Complexity mode, generation of a predicted image and computation of the motion vector information, prediction mode information, and the header bit of the flag information are performed for all of the candidate prediction modes as a process performed in step S41. Thus, the cost function value expressed in the following equation (34) is computed for each of the prediction modes and, thereafter, the prediction mode that provides a minimum cost function value is selected as an optimal prediction mode.

Cost(Mode)=D+QPtoQuant(QP)·HeaderBit (34)

D denotes the difference (distortion) between the original image and the decoded image, Header_Bit denotes a header bit for the prediction mode, and QPtoQuant denotes a function provided in the form of a function of a quantization parameter QP.

In the Low Complexity mode, only a predicted image is generated for each of the prediction mode. An encoding process and a decoding process need not be performed. Accordingly, the amount of computation can be reduced.

In step S43, the intra prediction unit 74 determines an optimal mode for each of the 4×4 pixel, 8×8 pixel, and 16×16 pixel intra prediction modes. That is, as described above with reference to FIG. 11, in the case of the 4×4 pixel and 8×8 pixel intra prediction modes, there are nine types of prediction mode. In the case of the 16×16 pixel intra prediction mode, there are four types of prediction modes. Accordingly, from among these prediction modes, the intra prediction unit 74 selects the optimal 4×4 intra prediction mode, the optimal 8×8 intra prediction mode, and the optimal 16×16 intra prediction mode on the basis of the cost function values computed in step S42.

In step S44, from among the optimal modes selected for the 4×4 pixel, 8×8 pixel, and the 16×16 pixel intra prediction modes, the intra prediction unit 74 selects one of the intra prediction modes on the basis of the cost function values computed in step S42. That is, from among the optimal modes selected for the 4×4 pixels, 8×8 pixels, and the 16×16 pixels, the intra prediction unit 74 selects the mode having the minimum cost function value.

The inter motion prediction process performed in step S33 shown in FIG. 7 is described next with reference to a flowchart shown in FIG. 19.

In step S51, the motion prediction/compensation unit 75 determines the motion vector and the reference image for each of the eight 16×16 pixel to 4×4 pixel inter prediction modes illustrated in FIG. 4. That is, the motion vector and the reference image are determined for a block to be processed for each of the inter prediction modes.

In step S52, the motion prediction/compensation unit 75 performs a motion prediction and compensation process on the reference image for each of the eight 16×16 pixel to 4×4 pixel inter prediction modes on the basis of the motion vector determined in step S51. Through the motion prediction and compensation process, a predicted image is generated for each of the inter prediction modes.

In step S53, the motion prediction/compensation unit 75 generates motion vector information to be added to the compressed image for the motion vector determined for each of the eight 16×16 pixel to 4×4 pixel inter prediction modes.

A method for generating the motion vector information in the H.264/AVC standard is described next with reference to FIG. 20. In the example shown in FIG. 20, a target block E to be encoded next (e.g., 16×16 pixels) and blocks A to D that have already been encoded and that are adjacent to the target block E are shown.

That is, the block D is adjacent to the upper left corner of the target block E. The block B is adjacent to the upper end of the target block E. The block C is adjacent to the upper right corner of the target block E. The block A is adjacent to the left end of the target block E. Note that the entirety of each of the blocks A to D is not shown, since the blocks A to D is one of 16×16 pixel to 4×4 pixel blocks illustrated in FIG. 4.

For example, let mvX denote motion vector information for X (=A, B, C, D, E). Prediction motion vector information (a predicted value of the motion vector) pmvE for the target block E is expressed using the motion vector information regarding the blocks A, B, and C and a median operation using the following equation (35).

pmvE=med(mvA,mvB,mvC) (35)

If the motion vector information regarding the block C is unavailable because, for example, the block C is located at the end of the image frame or the block C has not yet been encoded, the motion vector information regarding the block D is used in stead of the motion vector information regarding the block C.

Data mvdE to be added to the header portion of the compressed image as the motion vector information regarding the target block E is given using pmvE and the following equation (36).

mvdE=mvE−pmvE (36)

Note that in practice, the process is independently performed for a horizontal-direction component and a vertical-direction component of the motion vector information.

In this way, the prediction motion vector information is generated, and a difference between the prediction motion vector information generated using a correlation between neighboring blocks and the motion vector information is added to the header portion of the compressed image. Thus, the motion vector information can be reduced.

The motion vector information generated in the above-described manner is also used for computation of the cost function value performed in the subsequent step S54. If the predicted image corresponding to the motion vector information is finally selected by the predicted image selecting unit 78, the motion vector information is output to the lossless encoding unit 66 together with the inter prediction mode information and the reference frame information.

Referring back to FIG. 19, in step S54, the motion prediction/compensation unit 75 computes the cost function value for each of the eight 16×16 pixel to 4×4 pixel inter prediction modes using equation (33) or (34) described above. The cost function values computed here are used for selecting the optimal inter prediction mode in step S35 shown in FIG. 7 as described above.

Note that the computation of the cost function value for the inter prediction mode includes evaluation of the cost function value in the Skip mode and Direct mode defined in the H.264/AVC standard.

The inter-template weighted prediction method is described next.

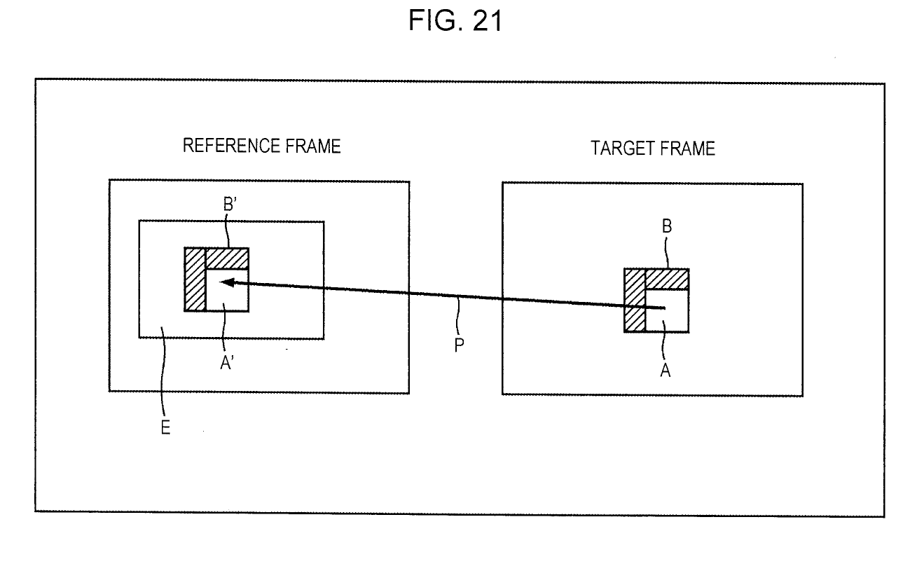

The inter-template matching method is described first with reference to FIG. 21.

In the example shown in FIG. 21, a target frame to be encoded and a reference frame referenced when a motion vector is searched for are shown. In the target frame, a target block A to be encoded next and a template region B including pixels that are adjacent to the target block A and that have already been encoded are shown. That is, as shown in FIG. 21, when an encoding process is performed in the raster scan order, the template region B is located on the left of the target block A and on the upper side of the target block A. In addition, the decoded image of the template region B is stored in the frame memory 72.

The inter-TP motion prediction/compensation unit 76 performs a matching process within a predetermined search area E of the reference frame using, for example, SAD (Sum of Absolute Difference) as a cost function value. The inter-TP motion prediction/compensation unit 76 searches for a region B′ having the highest correlation with the pixel values of the template region B. Thereafter, the inter-TP motion prediction/compensation unit 76 considers a block A′ corresponding to the searched region B′ as a predicted image for the target block A and searches for a motion vector P for the target block A. That is, in the inter-template matching method, by performing a matching process of a template that represents an already decoded region, the motion vector of the target block to be encoded can be searched for, and the motion of the target block to be encoded can be predicted.

In this way, in the motion vector search process using the inter-template matching method, a decoded image is used for the template matching process. Accordingly, by predefining the predetermined search area E, the same process can be performed in the image encoding apparatus 51 shown in FIG. 3 and an image decoding apparatus (described below). That is, by providing an inter-TP motion prediction/compensation unit in the image decoding apparatus as well, information regarding the motion vector P for the target block A need not be sent to the image decoding apparatus. Therefore, the motion vector information included in a compressed image can be reduced.

Note that the predetermined search area E is a search area at the center of which there is a motion vector (0, 0), for example. Alternatively, as described above with reference to FIG. 20, the predetermined search area E may be a search area at the center of which there is the predicted motion vector information generated using the correlation with a neighboring block.

In the inter-template weighted prediction method, if explicit weighted prediction is used as weighted prediction, the predicted image computed using the above-described inter-template matching method is selected as a predicted image P(L0) of the List0 reference frame. Thereafter, the computation indicated by the above-described equation (1) is performed on a P picture serving as an image to be subjected to inter prediction.

In addition, for a B picture serving as an image to be subjected to inter prediction, two predicted images computed using the above-described inter-template matching method are selected as a predicted image P(L0) of the List0 reference frame and a predicted image P(L1) of the List1 reference frame. Thereafter, the computation indicated by the above-described equation (2) is performed. Note that if explicit weighted prediction is used as weighted prediction, the values determined on a per picture basis by the weighting coefficient computing unit 77 are used as the weighting coefficient and the offset value.

In contrast, in the inter-template weighted prediction method, if implicit weighted prediction is used as weighted prediction, the predicted image is obtained as follows.

First, the case in which an image to be subjected to inter prediction is a P picture is described.

In such a case, in order to compute a predicted image, either a method for computing a predicted image on the basis of the weighting coefficient or a method for computing a predicted image on the basis of the offset value can be used.

In the method for computing a predicted image on the basis of the weighting coefficient, the weighting coefficient computing unit 77 computes the average value of the pixel values in the template region B and the average value of the pixel values in the region B′ (FIG. 21) of the inter-template matching method. These average values are denoted as Ave(B) and Ave(B′). Thereafter, the weighting coefficient computing unit 77 computes the weighting coefficient w₀ using the average values Ave(B) and Ave(B′) and the following equation (37).

$$\begin{matrix}[ Math . 13 ] & \\ {w}_{0} = \frac{Ave ( {B}^{′} )}{Ave ( B )} & ( 37 )\end{matrix}$$

Accordingly, even in the same P picture, the weighting coefficient w₀ has different values for the individual template matching blocks.

The inter-TP motion prediction/compensation unit 76 computes a predicted pixel value Pred(A) of the block A using the weighting coefficient w₀, the pixel value Pix(A′) of the block A′, and the following equation (38).

Pred(A)=w₀×Pix(A′) (38)

As described above, the inter-TP motion prediction/compensation unit 76 generates a predicted image using the weighting coefficient w₀ obtained for each of the template matching blocks. Accordingly, a predicted image suitable for the characteristics of the local pixel values in the screen can be generated.

Note that the weighting coefficient w₀ obtained using equation (37) may be approximated to a value in the form of X/(2ⁿ). In such a case, division can be realized using a bit shift operation. Accordingly, the amount of computation required for weighted prediction can be reduced.

By contrast, in the method for computing a predicted image on the basis of the offset value, the weighting coefficient computing unit 77 computes an offset value d₀ using the average values Ave(B) and Ave(B′) and the following equation (39).

d₀=Ave(B)−Ave(B′) (39)

Accordingly, even in the same P picture, the offset values d₀ become different values for the individual template matching blocks.

The inter-TP motion prediction/compensation unit 76 computes a predicted pixel value Pred(A) of the block A using the offset value d₀, the predicted pixel value Pred(A′) of the block A, and the following equation (40).

Pred(A)=Pred(A′)+d₀ (40)

As described above, the inter-TP motion prediction/compensation unit 76 generates a predicted image using the offset value d₀ obtained for each of the template matching blocks. Accordingly, a predicted image suitable for the characteristics of the local pixel values in the screen can be generated.

The case in which an image to be subjected to inter prediction is a B picture is described next.

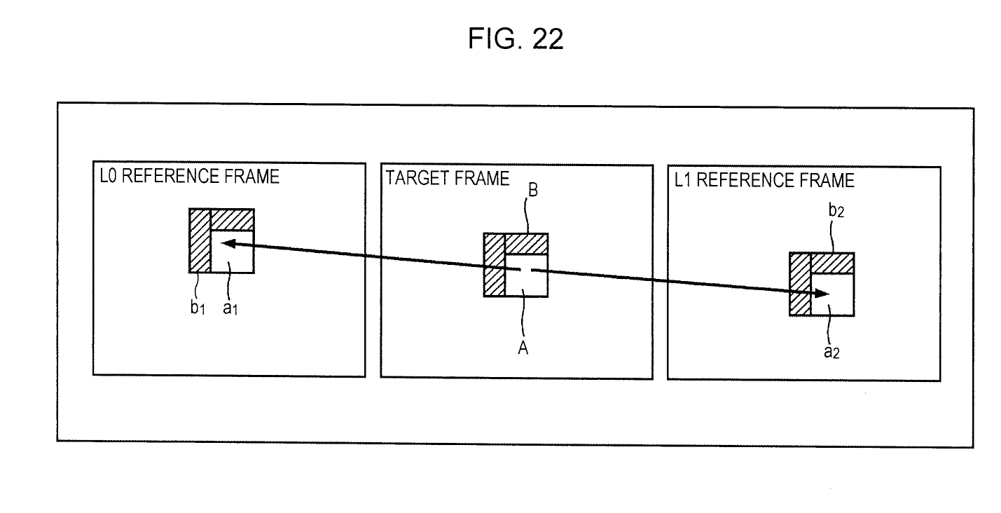

In such a case, as shown in FIG. 22, in the inter-template matching method, a target frame to be encoded is used. In addition, the L0 reference frame and the L1 reference frame are used as reference frames referenced when a motion vector is searched for. Thereafter, within a predetermined search area of the L0 reference frame, a matching process that is the same as the matching process illustrated in FIG. 21 is performed. Thus, a block a₁ corresponding to the searched region b₁ is selected as a predicted image. In addition, a similar matching process is performed for the L1 reference frame, and a block a₂ corresponding to the searched region b₂ is selected as a predicted image.

The weighting coefficient computing unit 77 computes the average values of the pixel values in the template region B, the region b₁, and the region b₂, which are defined as Ave_tmplt_Cur, Ave_tmplt_L0, and Ave_tmplt_L1, respectively. Thereafter, the weighting coefficient computing unit 77 computes the weighting coefficients w₀ and w₁ using the average values Ave_tmplt_Cur, Ave_tmplt_L0, Ave_tmplt_L1, and the following equations (41).

w₀=|Ave_tmplt_{—}L1−Ave_tmplt_Cur|

w₁=|Ave_tmplt_{—}L0−Ave_tmplt_Cur| (41)

In addition, the weighting coefficient computing unit 77 normalizes, using the following equation (42), the weighting coefficients w₀ and w₁ computed using equation (41).

$$\begin{matrix}[ Math . 14 ] & \\ {w}_{0} = \frac{{W}_{0}}{{W}_{0} + {W}_{1}} ; \\ {w}_{1} = \frac{{W}_{1}}{{W}_{0} + {W}_{1}} & ( 42 )\end{matrix}$$

Accordingly, even in the same B picture, the weighting coefficients w₀ and w₁ have different values for the individual template matching blocks.

The inter-TP motion prediction/compensation unit 76 computes a predicted pixel value Pred(A) of the block A using the weighting coefficients w₀ and w₁, a pixel value Pix_L0 of the block a₁, a pixel value Pix_L1 of the block a₂, and the following equation (43).

Pred(A)=w₀×Pix_{—}L₀+w₁×Pix_{—}L1 (43)

As described above, the inter-TP motion prediction/compensation unit 76 generates a predicted image using the weighting coefficients w₀ and w₁ obtained for each of the template matching blocks. Accordingly, a predicted image suitable for the characteristics of the local pixel values in the screen can be generated.

Note that the weighting coefficients w₀ and w₁ obtained using equation (42) may be approximated to values in the form of X/(2ⁿ). In such a case, division can be realized using a bit shift operation. Accordingly, the amount of computation required for weighted prediction can be reduced.

In this way, in the image encoding apparatus 51, the weighting coefficient used for the implicit weighted prediction is computed. Accordingly, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

The inter template motion prediction process performed in step S34 shown in FIG. 7 is described in more detail next with reference to a flowchart shown in FIG. 23.

In step S71, the inter-TP motion prediction/compensation unit 76 searches for a motion vector using the inter-template matching method. In step S72, the inter-TP motion prediction/compensation unit 76 determines whether the inter-template weighted prediction method is employed as a method for a motion prediction/compensation process.

If, in step S72, it is determined that the inter-template weighted prediction method is employed as a method for a motion prediction/compensation process, the inter-TP motion prediction/compensation unit 76, in step S73, determines whether explicit weighted prediction is employed as weighted prediction.

If, in step S73, it is determined that explicit weighted prediction is employed as weighted prediction, the inter-TP motion prediction/compensation unit 76, in step S74, generates a predicted image using the weighting coefficient and the offset value determined for each of the pictures by the weighting coefficient computing unit 77, the block A of a reference frame indicated by the motion vector searched for in step S71 or the blocks a1 and a2, and using the above-described equation (1) or (2).

However, if, in step S73, it is determined that explicit weighted prediction is not employed as weighted prediction, that is, if it is determined that implicit weighted prediction is employed as weighted prediction, the processing proceeds to step S75. In step S75, the weighting coefficient computing unit 77 computes the weighting coefficient using an image supplied from the inter-TP motion prediction/compensation unit 76.

More specifically, if an image to be inter predicted is a P picture, the weighting coefficient computing unit 77 computes the weighting coefficient using the decoded images of the template region B and the region B′ and the above-described equation (37). However, if an image to be inter predicted is a B picture, the weighting coefficient computing unit 77 computes the weighting coefficient using the decoded images of the template region B, the region b₁, and the region b₂ and the above-described equations (41) and (42). Note that if an image to be inter predicted is a P picture, the weighting coefficient computing unit 77 may compute the offset value using the decoded images of the template region B and the region B′ and the above-described equation (39).

In step S76, the inter-TP motion prediction/compensation unit 76 generates a predicted image using the weighting coefficient computed in step S75 and the above-described equation (38) or (43). Note that when the offset value is computed by the weighting coefficient computing unit 77, the inter-TP motion prediction/compensation unit 76 generates a predicted image using the above-described equation (40).

However, if, in step S72, it is determined that the inter-template weighted prediction method is not employed as a method for a motion prediction/compensation process, that is, if the inter-template method is employed as a method for a motion prediction/compensation process, the processing proceeds to step S77.

In step S77, the inter-TP motion prediction/compensation unit 76 generates a predicted image on the basis of the motion vector searched for in step S71. For example, the inter-TP motion prediction/compensation unit 76 directly selects the image of the region A′ as a predicted image on the basis of the motion vector P.

After the process performed in step S74, S76, or S77 is completed, the inter-TP motion prediction/compensation unit 76, in step S78, computes the cost function value for the inter-template prediction mode.

In this way, the inter-template motion prediction process is performed.

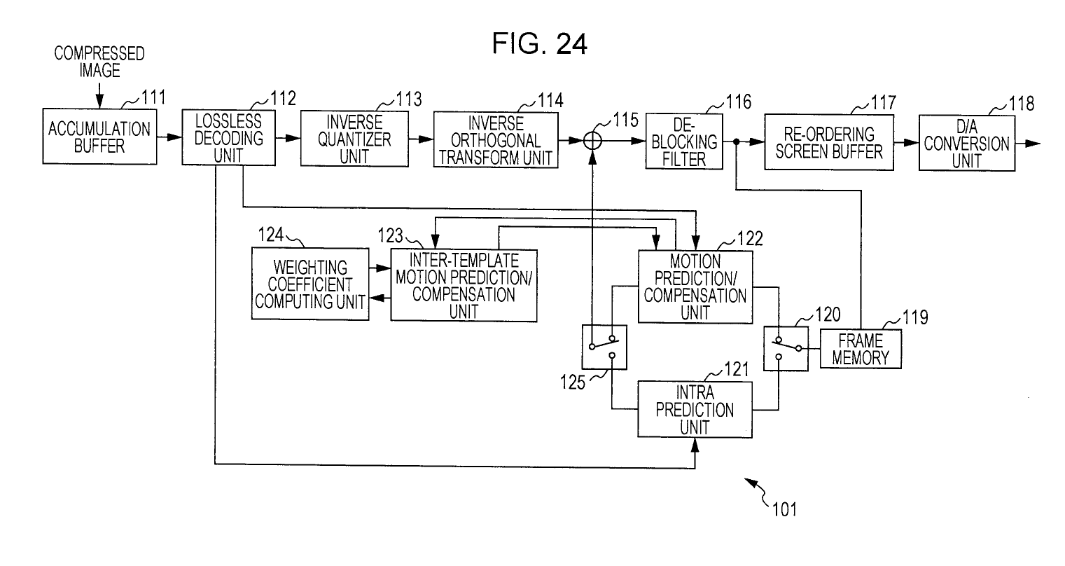

In addition, the image encoded and compressed by the image encoding apparatus 51 is transferred via a predetermined transmission path and is decoded by an image decoding apparatus. FIG. 24 illustrates the configuration of such an image decoding apparatus according to an embodiment of the present invention.

An image decoding apparatus 101 includes an accumulation buffer 111, a lossless decoding unit 112, an inverse quantizer unit 113, an inverse orthogonal transform unit 114, a computing unit 115, a de-blocking filter 116, a re-ordering screen buffer 117, a D/A conversion unit 118, a frame memory 119, a switch 120, an intra prediction unit 121, a motion prediction/compensation unit 122, an inter-template motion prediction/compensation unit 123, a weighting coefficient computing unit 124, and a switch 125.

Note that hereinafter, the inter-template motion prediction/compensation unit 123 is referred to as an “inter-TP motion prediction/compensation unit 123”.

The accumulation buffer 111 accumulates transmitted compressed images. The lossless decoding unit 112 decodes information encoded by the lossless encoding unit 66 shown in FIG. 3 using a method corresponding to the encoding method employed by the lossless encoding unit 66 and supplied from the accumulation buffer 111. The inverse quantizer unit 113 inverse quantizes an image decoded by the lossless decoding unit 112 using a method corresponding to the quantizing method employed by the quantizer unit 65 shown in FIG. 3. The inverse orthogonal transform unit 114 inverse orthogonal transforms the output of the inverse quantizer unit 113 using a method corresponding to the orthogonal transform method employed by the orthogonal transform unit 64 shown in FIG. 3.

The inverse orthogonal transformed output is added to the predicted image supplied from the switch 125 and is decoded by the computing unit 115. The de-blocking filter 116 removes block distortion of the decoded image and supplies the image to the frame memory 119. Thus, the image is accumulated. At the same time, the image is output to the re-ordering screen buffer 117.

The re-ordering screen buffer 117 re-orders images. That is, the order of frames that has been changed by the re-ordering screen buffer 62 shown in FIG. 3 for encoding is changed back to the original display order. The D/A conversion unit 118 D/A-converts an image supplied from the re-ordering screen buffer 117 and outputs the image to a display (not shown), which displays the image.

The switch 120 reads, from the frame memory 119, an image to be inter coded and an image to be referenced. The switch 120 outputs the images to the motion prediction/compensation unit 122. In addition, the switch 120 reads an image used for intra prediction from the frame memory 119 and supplies the readout image to the intra prediction unit 121.

The intra prediction unit 121 receives, from the lossless decoding unit 112, information regarding an intra prediction mode obtained by decoding the header information. When the information regarding an intra prediction mode is supplied, the intra prediction unit 121 generates a predicted image on the basis of such information. The intra prediction unit 121 outputs the generated predicted image to the switch 125.

The motion prediction/compensation unit 122 receives information obtained by decoding the header information (e.g., the prediction mode information, the motion vector information, the template method information, the weighting coefficient, and the offset value) from the lossless decoding unit 112. Upon receiving inter prediction mode information as the prediction mode information, the motion prediction/compensation unit 122 performs a motion prediction and compensation process on the image on the basis of the motion vector information and the reference frame information and generates a predicted image.

In contrast, upon receiving inter-template prediction mode information as the prediction mode information, the motion prediction/compensation unit 122 supplies, to the inter-TP motion prediction/compensation unit 123, the image to be inter coded and the reference image read from the frame memory 119. The inter-TP motion prediction/compensation unit 123 performs a motion prediction/compensation process in an inter-template prediction mode. Note that at that time, the template method information supplied from the lossless decoding unit 112 is also supplied to the inter-TP motion prediction/compensation unit 123. In addition, if the weighting coefficient and the offset value are supplied from the lossless decoding unit 112, the weighting coefficient and the offset value are also supplied to the inter-TP motion prediction/compensation unit 123.

In addition, the motion prediction/compensation unit 122 outputs, to the switch 125, one of the predicted image generated in the inter prediction mode and the predicted image generated in the inter-template prediction mode in accordance with the prediction mode information.

Like the inter-TP motion prediction/compensation unit 76 shown in FIG. 3, the inter-TP motion prediction/compensation unit 123 performs a motion prediction and compensation process in the inter-template prediction mode in accordance with the template method information supplied from the motion prediction/compensation unit 122. That is, the inter-TP motion prediction/compensation unit 123 performs a motion prediction and compensation process in the inter-template prediction mode on the basis of the image to be inter encoded and the reference image read from the frame memory 119 using the inter-template weighted prediction method or the inter-template matching method. As a result, a predicted image is generated.

Note that when the motion prediction and compensation process is performed using the inter-template weighted prediction method and if the template method information indicates that explicit weighted prediction is employed as weighted prediction, the inter-TP motion prediction/compensation unit 123 generates the predicted image using the weighting coefficient and the offset value supplied from the motion prediction/compensation unit 122, like the inter-TP motion prediction/compensation unit 76 shown in FIG. 3.

However, if the template method information indicates that implicit weighted prediction is employed as weighted prediction, the inter-TP motion prediction/compensation unit 123 supplies, to the weighting coefficient computing unit 124, the template region of the target frame used in the inter-template matching method and the image of a region of the reference frame that has a high correlation with the template region. Thereafter, like the inter-TP motion prediction/compensation unit 76 shown in FIG. 3, the inter-TP motion prediction/compensation unit 123 generates a predicted image using the weighting coefficient or the offset value supplied from the weighting coefficient computing unit 124 in accordance with the image.

Like the weighting coefficient computing unit 77 shown in FIG. 3, the weighting coefficient computing unit 124 computes the weighting coefficient or the offset value using the template region and the image of a region of the reference frame that has a high correlation with the template region supplied from the inter-TP motion prediction/compensation unit 123.

The predicted image generated through the motion prediction/compensation process in the inter-template prediction mode is supplied to the motion prediction/compensation unit 122.

The switch 125 selects one of the predicted image generated by the motion prediction/compensation unit 122 and the predicted image generated by the intra prediction unit 121 and supplies the selected one to the computing unit 115.

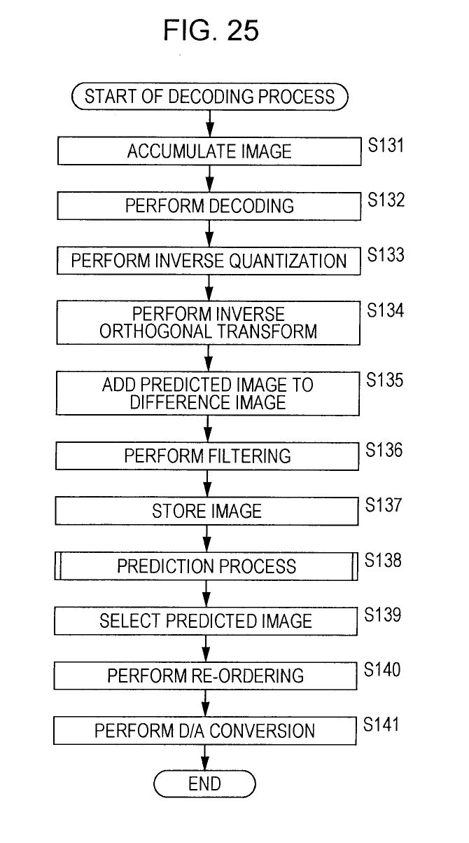

The decoding process performed by the image decoding apparatus 101 is described next with reference to a flowchart shown in FIG. 25.

In step S131, the accumulation buffer 111 accumulates a transferred image. In step S132, the lossless decoding unit 112 decodes a compressed image supplied from the accumulation buffer 111. That is, the I picture, the P picture, and the B picture encoded by the lossless encoding unit 66 shown in FIG. 3 are decoded.

At that time, the motion vector information and the prediction mode information (information indicating one of an intra prediction mode, an inter prediction mode, and an inter-template prediction mode) are also decoded. That is, if the prediction mode information indicates an intra prediction mode, the prediction mode information is supplied to the intra prediction unit 121. However, if the prediction mode information indicates an inter prediction mode or the inter-template prediction mode, the prediction mode information is supplied to the motion prediction/compensation unit 122. At that time, if the associated motion vector information, reference frame information, template method information, weighting coefficient, or offset value is present, that information is also supplied to the motion prediction/compensation unit 122.

In step S133, the inverse quantizer unit 113 inverse quantizes the transform coefficients decoded by the lossless decoding unit 112 using the characteristics corresponding to the characteristics of the quantizer unit 65 shown in FIG. 3. In step S134, the inverse orthogonal transform unit 114 inverse orthogonal transforms the transform coefficients inverse quantized by the inverse quantizer unit 113 using the characteristics corresponding to the characteristics of the orthogonal transform unit 64 shown in FIG. 3. In this way, the difference information corresponding to the input of the orthogonal transform unit 64 shown in FIG. 3 (the output of the computing unit 63) is decoded.

In step S135, the computing unit 115 adds the predicted image selected in step S139 described below and input via the switch 125 to the difference information. In this way, the original image is decoded. In step S136, the de-blocking filter 116 performs filtering on the image output from the computing unit 115. Thus, block distortion is removed.

In step S137, the frame memory 119 stores the filtered image.

In step S138, the intra prediction unit 121, the motion prediction/compensation unit 122, or the inter-TP motion prediction/compensation unit 123 performs an image prediction process in accordance with the prediction mode information supplied from the lossless decoding unit 112.

That is, when information indicating the intra prediction mode (hereinafter referred to as “intra prediction mode information”) is supplied from the lossless decoding unit 112, the intra prediction unit 121 performs an intra prediction process in the intra prediction mode. However, when the inter prediction mode information is supplied from the lossless decoding unit 112, the motion prediction/compensation unit 122 performs a motion prediction/compensation process in the inter prediction mode. When the inter-template prediction mode information is supplied from the lossless decoding unit 112, the inter-TP motion prediction/compensation unit 123 performs a motion prediction/compensation process in the inter-template prediction mode.

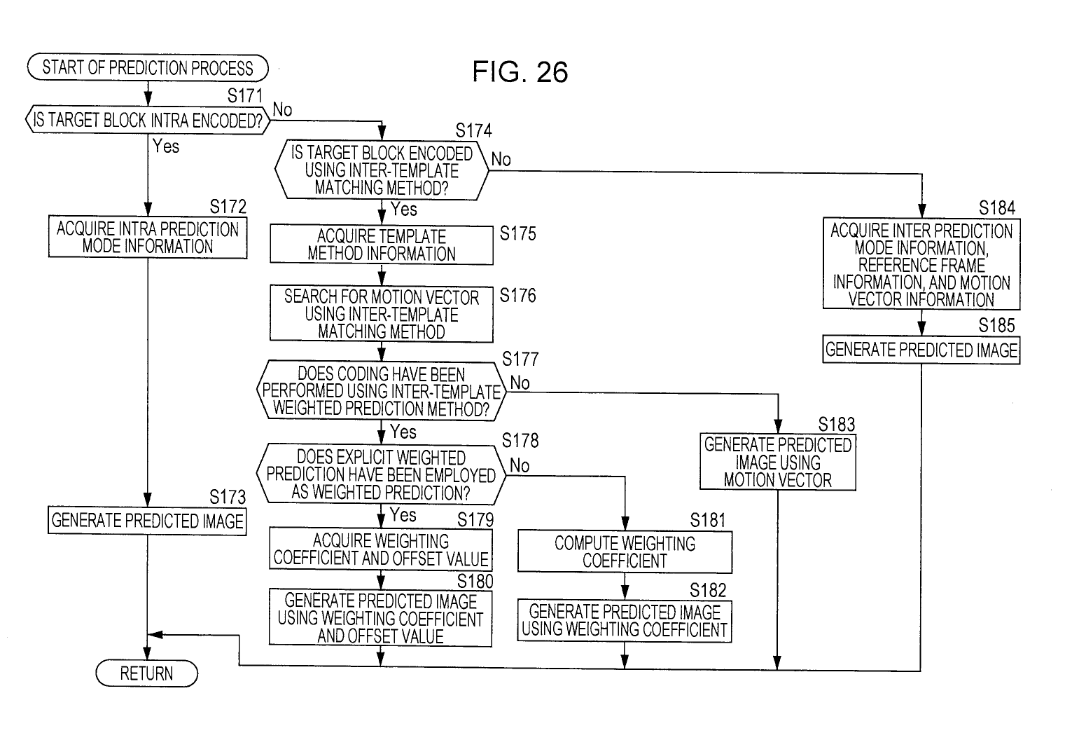

The prediction process performed in step S138 is described below with reference to FIG. 26. Through this process, the predicted image generated by the intra prediction unit 121, the predicted image generated by the motion prediction/compensation unit 122, or the predicted image generated by the inter-TP motion prediction/compensation unit 123 is supplied to the switch 125.

In step S139, the switch 125 selects the predicted image. That is, since the predicted image generated by the intra prediction unit 121, the predicted image generated by the motion prediction/compensation unit 122, or the predicted image generated by the inter-TP motion prediction/compensation unit 123 is supplied, the supplied predicted image is selected and supplied to the computing unit 115. As described above, in step S134, the predicted image is added to the output of the inverse orthogonal transform unit 114.

In step S140, the re-ordering screen buffer 117 performs a re-ordering process. That is, the order of frames that has been changed by the re-ordering screen buffer 62 of the image encoding apparatus 51 for encoding is changed back to the original display order.

In step S141, the D/A conversion unit 118 D/A-converts images supplied from the re-ordering screen buffer 117. The images are output to a display (not shown), which displays the images.

The prediction process performed in step S138 shown in FIG. 25 is described next with reference to a flowchart shown in FIG. 26.

In step S171, the intra prediction unit 121 determines whether the target block is intra coded. If intra prediction mode information is supplied from the lossless decoding unit 112 to the intra prediction unit 121, the intra prediction unit 121, in step S171, determines that the target block has been intra coded. Thus, the processing proceeds to step S172.

In step S172, the intra prediction unit 121 acquires the intra prediction mode information.

In step S173, the images required for the processing are read from the frame memory 119. In addition, the intra prediction unit 121 performs intra prediction in accordance with the intra prediction mode information acquired in step S172 and generates a predicted image. Thereafter, the processing is completed.

However, if, in step S171, it is determined that the target block has not been intra coded, the processing proceeds to step S174. In such a case, since the image to be processed is an image to be inter processed, necessary images are read from the frame memory 119 and are supplied to the motion prediction/compensation unit 122 via the switch 120.

In step S174, the motion prediction/compensation unit 122 determines whether the target block has been encoded using the inter-template matching method. If inter-template prediction mode information is supplied from the lossless decoding unit 112 to the motion prediction/compensation unit 122, the motion prediction/compensation unit 122 determines that the target block has been encoded using the inter-template matching method in step S174, and the processing proceeds to step S175.

In step S175, the motion prediction/compensation unit 122 acquires the template method information from the lossless decoding unit 112 and supplies the template method information to the inter-TP motion prediction/compensation unit 123. In step S176, the inter-TP motion prediction/compensation unit 123 searches for a motion vector using the inter-template matching method.

In step S177, the inter-TP motion prediction/compensation unit 123 determines whether the target block has been encoded using the inter-template weighted prediction method. If the template method information acquired from the lossless decoding unit 112 indicates that the inter-template weighted prediction method is employed as the motion prediction/compensation method, the inter-TP motion prediction/compensation unit 123, in step S177, determines that the target block has been encoded using the inter-template weighted prediction method. Thus, the processing proceeds to step S178.

In step S178, the inter-TP motion prediction/compensation unit 123 determines whether explicit weighted prediction is employed as weighted prediction among inter-template weighted prediction methods. If the template method information acquired from the lossless decoding unit 112 indicates that explicit weighted prediction is employed as weighted prediction, it is determined in step S178 that explicit weighted prediction is employed as weighted prediction. Thus, the processing proceeds to step S179.

In step S179, the inter-TP motion prediction/compensation unit 123 acquires the weighting coefficient and the offset value supplied from the lossless decoding unit 112 via the motion prediction/compensation unit 122.

In step S180, the inter-TP motion prediction/compensation unit 123 generates a predicted image using the weighting coefficient and the offset value acquired in step S179, the image corresponding to the motion vector searched for in step S176, and the above-described equation (1) or (2). Thereafter, the processing is completed.

However, if the template method information acquired from the lossless decoding unit 112 indicates that implicit weighted prediction is employed as weighted prediction, it is determined in step S178 that explicit weighted prediction is not employed as weighted prediction. Thus, the processing proceeds to step S181.

In step S181, the weighting coefficient computing unit 124 computes the weighting coefficient using the above-described equation (37) or equations (41) and (42). Note that if the image to be inter predicted is a P picture, the weighting coefficient computing unit 77 may compute the offset value using the above-described equation (39).

In step S182, the inter-TP motion prediction/compensation unit 123 generates a predicted image using the weighting coefficient computed in step S181 and the above-described equation (38) or (43). Note that if the offset value is computed by the weighting coefficient computing unit 77, the inter-TP motion prediction/compensation unit 123 generates a predicted image using the above-described equation (40). Thereafter, the processing is completed.

However, if the template method information acquired from the lossless decoding unit 112 indicates that the inter-template method is employed as the motion prediction/compensation method, it is determined in step S177 that the target block has not been encoded using the inter-template weighted prediction method. Thus, the processing proceeds to step S183.

In step S183, the inter-TP motion prediction/compensation unit 123 generates a predicted image on the basis of the motion vector searched for in step S176.

In addition, if the inter prediction mode information is supplied from the lossless decoding unit 112 to the motion prediction/compensation unit 122, it is determined in step S174 that the target block has not been encoded using the inter-template matching method. Thus, the processing proceeds to step S184.

In step S184, the motion prediction/compensation unit 122 acquires the inter prediction mode information, the reference frame information, and the motion vector information from the lossless decoding unit 112.

In step S185, the motion prediction/compensation unit 122 performs motion prediction in the inter prediction mode on the basis of the inter prediction mode information, the reference frame information, and the motion vector information acquired in step S184.

In this way, the prediction process is performed.

As described above, according to the present invention, in the image encoding apparatus and the image decoding apparatus, motion prediction is performed for an image to be inter predicted using the inter-template matching method in which a motion search is performed using a decoded image. Therefore, an image having excellent image quality can be displayed without sending the motion vector information.

While above description has been made with reference to a macroblock having a size of 16×16 pixels, the present invention can be applied to the extended macroblock size described in “Video Coding Using Extended Block Sizes”, VCEG-AD09, ITU-Telecommunications Standardization Sector STUDY GROUP Question 16—Contribution 123, January 2009.

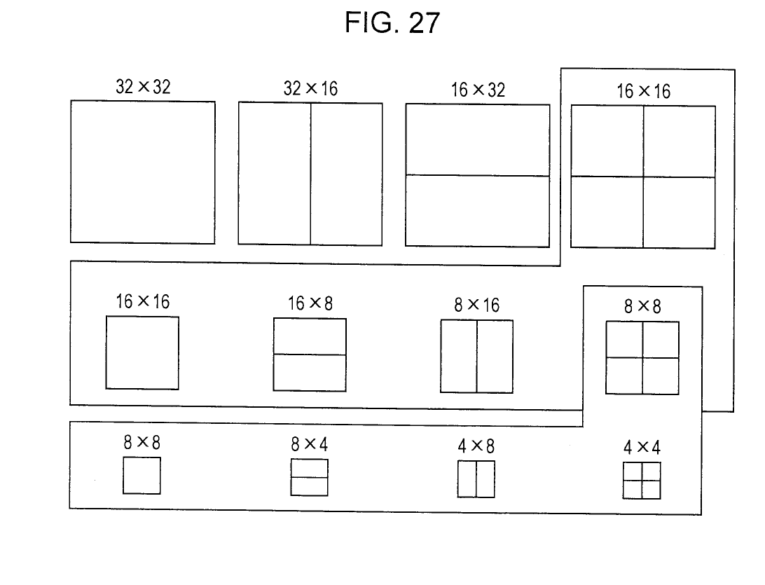

FIG. 27 illustrates an example of the extended macroblock size. In the above description, the macroblock size is extended to a size of 32×32 pixels.

In the upper section of FIG. 27, macroblocks that have a size of 32×32 pixels and that are partitioned into blocks (partitions) having sizes of 32×32 pixels, 32×16 pixels, 16×32 pixels, and 16×16 pixels are shown from the left. In the middle section of FIG. 27, macroblocks that have a size of 16×16 pixels and that are partitioned into blocks having sizes of 16×16 pixels, 16×8 pixels, 8×16 pixels, and 8×8 pixels are shown from the left. In the lower section of FIG. 27, macroblocks that have a size of 8×8 pixels and that are partitioned into blocks having sizes of 8×8 pixels, 8×4 pixels, 4×8 pixels, and 4×4 pixels are shown from the left.

That is, the macroblock having a size of 32×32 can be processed using the blocks having sizes of 32×32 pixels, 32×16 pixels, 16×32 pixels, and 16×16 pixels shown in the upper section of FIG. 27.

In addition, as in the H.264/AVC standard, the block having a size of 16×16 pixels shown on the right in the upper section can be processed using the blocks having sizes of 16×16 pixels, 16×8 pixels, 8×16 pixels, and 8×8 pixels shown in the middle section.

Furthermore, as in the H.264/AVC standard, the block having a size of 8×8 pixels shown on the right in the middle section can be processed using the blocks having sizes of 8×8 pixels, 8×4 pixels, 4×8 pixels, and 4×4 pixels shown in the lower section.

In terms of the extended macroblock size, by employing such a layer structure, for a block having a size smaller than or equal to 16×16 pixels, a block having a larger size can be defined as a superset of the block while maintaining compatibility with the H.264/AVC standard.

In this way, the present invention can be applied to the proposed extended macroblock size.

While the above description has been made with reference to the H.264/AVC standard as an encoding/decoding method, the present invention is applicable to an image encoding apparatus and an image decoding apparatus using another encoding/decoding method in which a motion prediction/compensation process is performed on an another block-size basis.

In addition, the present invention is applicable to an image encoding apparatus and an image decoding apparatus used for receiving image information (a bit stream) compressed through the orthogonal transform (e.g., discrete cosine transform) and motion compensation as in the MPEG or H.26x standard via a network medium, such as satellite broadcasting, a cable TV (television), the Internet, or a cell phone or processing image information in a storage medium such as an optical or magnetic disk, or a flash memory.

The above-described series of processes can be executed not only by hardware but also by software. When the above-described series of processes are executed by software, the programs of the software are installed from a program recording medium into a computer incorporated into dedicated hardware or a computer that can execute a variety of functions by installing a variety of programs therein (e.g., a general-purpose personal computer).

Examples of the program recording medium that records a computer-executable program to be installed in a computer include a magnetic disk (including a flexible disk), an optical disk (including a CD-ROM (Compact Disc-Read Only Memory), a DVD (Digital Versatile Disc), and a magnetooptical disk), a removable medium which is a package medium formed from a semiconductor memory), and a ROM and a hard disk that temporarily or permanently stores the programs. The programs are recorded in the program recording medium using a wired or wireless communication medium, such as a local area network, the Internet, or digital satellite broadcasting, as needed.

In the present specification, the steps that describe the program include not only processes executed in the above-described time-series sequence, but also processes that may be executed in parallel or independently.

In addition, embodiments of the present invention are not limited to the above-described embodiments. Various modifications can be made without departing from the spirit of the present invention.

For example, the above-described image encoding apparatus 51 and image decoding apparatus 101 are applicable to any electronic apparatus. Examples of the application are described below.

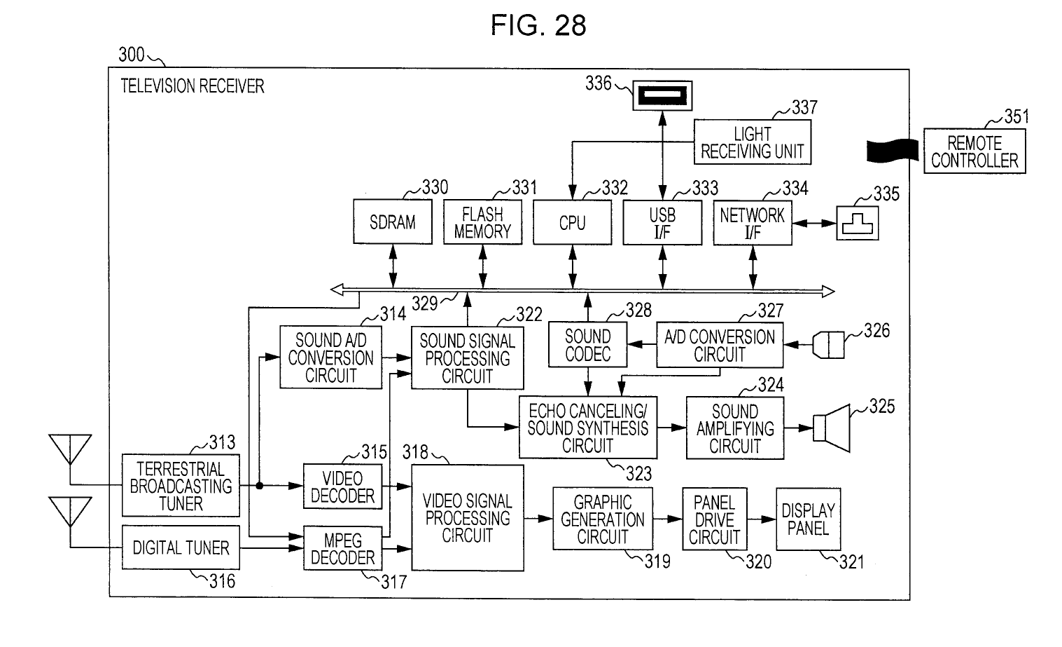

FIG. 28 is a block diagram of an example of the primary configuration of a television receiver using the image decoding apparatus according to the present invention.

As shown in FIG. 28, a television receiver 300 includes a terrestrial broadcasting tuner 313, a video decoder 315, a video signal processing circuit 318, a graphic generation circuit 319, a panel drive circuit 320, and a display panel 321.

The terrestrial broadcasting tuner 313 receives a broadcast signal of analog terrestrial broadcasting via an antenna, demodulates the broadcast signal, acquires a video signal, and supplies the video signal to the video decoder 315. The video decoder 315 performs a decoding process on the video signal supplied from the terrestrial broadcasting tuner 313 and supplies the resultant digital component signal to the video signal processing circuit 318.

The video signal processing circuit 318 performs a predetermined process, such as noise removal, on the video data supplied from the video decoder 315. Thereafter, the video signal processing circuit 318 supplies the resultant video data to the graphic generation circuit 319.

The graphic generation circuit 319 generates, for example, video data for a television program displayed on the display panel 321 and image data generated through the processing performed by an application supplied via a network. Thereafter, the graphic generation circuit 319 supplies the generated video data and image data to the panel drive circuit 320. In addition, the graphic generation circuit 319 generates video data (graphics) for displaying a screen used by a user who selects a menu item. The graphic generation circuit 319 overlays the video data on the video data of the television program. Thus, the graphic generation circuit 319 supplies the resultant video data to the panel drive circuit 320 as needed.

The panel drive circuit 320 drives the display panel 321 on the basis of the data supplied from the graphic generation circuit 319. Thus, the panel drive circuit 320 causes the display panel 321 to display the video of a television program and a variety of types of screen thereon.

The display panel 321 includes, for example, an LCD (Liquid Crystal Display). The display panel 321 displays, for example, the video of a television program under the control of the panel drive circuit 320.

The television receiver 300 further includes a sound A/D (Analog/Digital) conversion circuit 314, a sound signal processing circuit 322, an echo canceling/sound synthesis circuit 323, a sound amplifying circuit 324, and a speaker 325.

The terrestrial broadcasting tuner 313 demodulates a received broadcast signal. Thus, the terrestrial broadcasting tuner 313 acquires a sound signal in addition to the video signal. The terrestrial broadcasting tuner 313 supplies the acquired sound signal to the sound A/D conversion circuit 314.

The sound A/D conversion circuit 314 performs an A/D conversion process on the sound signal supplied from the terrestrial broadcasting tuner 313. Thereafter, the sound A/D conversion circuit 314 supplies the resultant digital sound signal to the sound signal processing circuit 322.

The sound signal processing circuit 322 performs a predetermined process, such as noise removal, on the sound data supplied from the sound A/D conversion circuit 314 and supplies the resultant sound data to the echo canceling/sound synthesis circuit 323.

The echo canceling/sound synthesis circuit 323 supplies the sound data supplied from the sound signal processing circuit 322 to the sound amplifying circuit 324.

The sound amplifying circuit 324 performs a D/A conversion process and an amplifying process on the sound data supplied from the echo canceling/sound synthesis circuit 323. After the sound data has a predetermined sound volume, the sound amplifying circuit 324 outputs the sound from the speaker 325.

The television receiver 300 further includes a digital tuner 316 and an MPEG decoder 317.

The digital tuner 316 receives a broadcast signal of digital broadcasting (terrestrial digital broadcasting and BS (Broadcasting Satellite)/CS (Communications Satellite) digital broadcasting) via an antenna and demodulates the broadcast signal. Thus, the digital tuner 316 acquires an MPEG-TS (Moving Picture Experts Group-Transport Stream) and supplies the MPEG-TS to the MPEG decoder 317.

The MPEG decoder 317 descrambles the MPEG-TS supplied from the digital tuner 316 and extracts a stream including television program data to be reproduced (viewed). The MPEG decoder 317 decodes sound packets of the extracted stream and supplies the resultant sound data to the sound signal processing circuit 322. In addition, the MPEG decoder 317 decodes video packets of the stream and supplies the resultant video data to the video signal processing circuit 318. Furthermore, the MPEG decoder 317 supplies EPG (Electronic Program Guide) data extracted from the MPEG-TS to a CPU 332 via a path (not shown).

The television receiver 300 uses the above-described image decoding apparatus 101 as the MPEG decoder 317 that decodes the video packets in this manner. Accordingly, like the image decoding apparatus 101, the MPEG decoder 317 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Like the video data supplied from the video decoder 315, the video data supplied from the MPEG decoder 317 is subjected to a predetermined process in the video signal processing circuit 318. Thereafter, the video data subjected to the predetermined process is overlaid on the generated video data in the graphic generation circuit 319 as needed. The video data is supplied to the display panel 321 via the panel drive circuit 320, and the image based on the video data is displayed.

Like the sound data supplied from the sound A/D conversion circuit 314, the sound data supplied from the MPEG decoder 317 is subjected to a predetermined process in the sound signal processing circuit 322. Thereafter, the sound data subjected to the predetermined process is supplied to the sound amplifying circuit 324 via the echo canceling/sound synthesis circuit 323 and is subjected to a D/A conversion process and an amplifying process. As a result, sound controlled so as to have a predetermined volume is output from the speaker 325.

The television receiver 300 further includes a microphone 326 and an A/D conversion circuit 327.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the echo canceling/sound synthesis circuit 323.

When voice data of a user (a user A) of the television receiver 300 is supplied from the A/D conversion circuit 327, the echo canceling/sound synthesis circuit 323 performs echo canceling on the voice data of the user A. After echo canceling is completed, the echo canceling/sound synthesis circuit 323 synthesizes the voice data with other sound data. Thereafter, the echo canceling/sound synthesis circuit 323 outputs the resultant sound data from the speaker 325 via the sound amplifying circuit 324.

The television receiver 300 still further includes a sound codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the sound codec 328.

The sound codec 328 converts the sound data supplied from the A/D conversion circuit 327 into data having a predetermined format in order to send the sound data via a network. The sound codec 328 supplies the sound data to the network I/F 334 via the internal bus 329.

The network I/F 334 is connected to the network via a cable attached to a network terminal 335. For example, the network I/F 334 sends the sound data supplied from the sound codec 328 to a different apparatus connected to the network. In addition, for example, the network I/F 334 receives sound data sent from a different apparatus connected to the network via the network terminal 335 and supplies the received sound data to the sound codec 328 via the internal bus 329.

The sound codec 328 converts the sound data supplied from the network I/F 334 into data having a predetermined format. The sound codec 328 supplies the sound data to the echo canceling/sound synthesis circuit 323.

The echo canceling/sound synthesis circuit 323 performs echo canceling on the sound data supplied from the sound codec 328. Thereafter, the echo canceling/sound synthesis circuit 323 synthesizes the sound data with other sound data and outputs the resultant sound data from the speaker 325 via the sound amplifying circuit 324.

The SDRAM 330 stores a variety of types of data necessary for the CPU 332 to perform processing.

The flash memory 331 stores a program executed by the CPU 332. The program stored in the flash memory 331 is read out by the CPU 332 at a predetermined timing, such as when the television receiver 300 is powered on. The flash memory 331 further stores the EPG data received through digital broadcasting and data received from a predetermined server via the network.

For example, the flash memory 331 stores an MPEG-TS including content data acquired from a predetermined server via the network under the control of the CPU 332. The flash memory 331 supplies the MPEG-TS to the MPEG decoder 317 via the internal bus 329 under the control of, for example, the CPU 332.

As in the case of the MPEG-TS supplied from the digital tuner 316, the MPEG decoder 317 processes the MPEG-TS. In this way, the television receiver 300 receives content data including video and sound via the network and decodes the content data using the MPEG decoder 317. Thereafter, the television receiver 300 can display the video and output the sound.

The television receiver 300 still further includes a light receiving unit 337 that receives an infrared signal transmitted from a remote controller 351.

The light receiving unit 337 receives an infrared light beam emitted from the remote controller 351 and demodulates the infrared light beam. Thereafter, the light receiving unit 337 outputs, to the CPU 332, control code that is received through the demodulation and that indicates the type of the user operation.

The CPU 332 executes the program stored in the flash memory 331 and performs overall control of the television receiver 300 in accordance with, for example, the control code supplied from the light receiving unit 337. The CPU 332 is connected to each of the units of the television receiver 300 via a path (not shown).

The USB I/F 333 communicates data with an external device connected to the television receiver 300 via a USB cable attached to a USB terminal 336. The network I/F 334 is connected to the network via a cable attached to the network terminal 335 and also communicates non-sound data with a variety of types of device connected to the network.

By using the image decoding apparatus 101 as the MPEG decoder 317, the television receiver 300 can perform weighted prediction on the basis of local characteristics of an image. As a result, the television receiver 300 can acquire a higher-resolution decoded image from the broadcast signal received via the antenna or content data received via the network and display the decoded image.

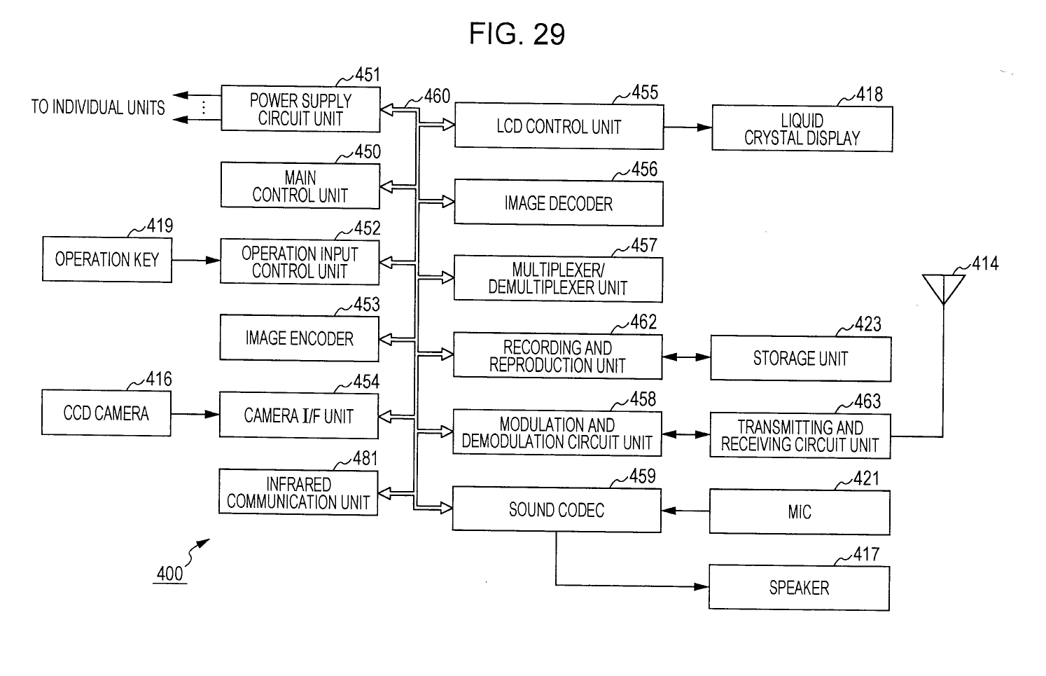

FIG. 29 is a block diagram of an example of a primary configuration of a cell phone using the image encoding apparatus and the image decoding apparatus according to the present invention.

As shown in FIG. 29, a cell phone 400 includes a main control unit 450 that performs overall control of units of the cell phone 400, a power supply circuit unit 451, an operation input control unit 452, an image encoder 453, a camera I/F unit 454, an LCD control unit 455, an image decoder 456, a multiplexer/demultiplexer unit 457, a recording and reproduction unit 462, a modulation and demodulation circuit unit 458, and a sound codec 459. These units are connected to one another via a bus 460.

The cell phone 400 further includes an operation key 419, a CCD (Charge Coupled Devices) camera 416, a liquid crystal display 418, a storage unit 423, a transmitting and receiving circuit unit 463, an antenna 414, a microphone (MIC) 421, and a speaker 417.

When call-ending is performed through a user operation or a power key is turned on, the power supply circuit unit 451 supplies the power from a battery pack to each unit. Thus, the cell phone 400 becomes operable.

Under the control of the main control unit 450 including a CPU, a ROM, and a RAM, the cell phone 400 performs a variety of operations, such as transmitting and receiving a voice signal, transmitting and receiving an e-mail and image data, image capturing, and data recording, in a variety of modes, such as a voice communication mode and a data communication mode.

For example, in the voice communication mode, the cell phone 400 converts a voice signal collected by the microphone (MIC) 421 into digital voice data using the sound codec 459. Thereafter, the cell phone 400 performs a spread spectrum process on the digital voice data using the modulation and demodulation circuit unit 458 and performs a digital-to-analog conversion process and a frequency conversion process on the digital voice data using the transmitting and receiving circuit unit 463. The cell phone 400 transmits a transmission signal obtained through the conversion process to a base station (not shown) via the antenna 414. The transmission signal (the voice signal) transmitted to the base station is supplied to a cell phone of a communication partner via a public telephone network.

In addition, for example, in the voice communication mode, the cell phone 400 amplifies a reception signal received by the antenna 414 using the transmitting and receiving circuit unit 463 and further performs a frequency conversion process and an analog-to-digital conversion process on the reception signal. The cell phone 400 further performs an inverse spread spectrum process on the reception signal using the modulation and demodulation circuit unit 458 and converts the reception signal into an analog voice signal using the sound codec 459. Thereafter, the cell phone 400 outputs the converted analog voice signal from the speaker 417.

Furthermore, for example, upon sending an e-mail in the data communication mode, the cell phone 400 receives text data of an e-mail input through operation of the operation key 419 using the operation input control unit 452. Thereafter, the cell phone 400 processes the text data using the main control unit 450 and displays the text data on the liquid crystal display 418 via the LCD control unit 455 in the form of an image.

Still furthermore, the cell phone 400 generates, using the main control unit 450, e-mail data on the basis of the text data and the user instruction received by the operation input control unit 452. Thereafter, the cell phone 400 performs a spread spectrum process on the e-mail data using the modulation and demodulation circuit unit 458 and performs a digital-to-analog conversion process and a frequency conversion process using the transmitting and receiving circuit unit 463. The cell phone 400 transmits a transmission signal obtained through the conversion processes to a base station (not shown) via the antenna 414. The transmission signal (the e-mail) transmitted to the base station is supplied to a predetermined address via a network and a mail server.

In addition, for example, in order to receive an e-mail in the data communication mode, the cell phone 400 receives a signal transmitted from the base station via the antenna 414 using the transmitting and receiving circuit unit 463, amplifies the signal, and further performs a frequency conversion process and an analog-to-digital conversion process on the signal. The cell phone 400 performs an inverse spread spectrum process on the reception signal and restores the original e-mail data using the modulation and demodulation circuit unit 458. The cell phone 400 displays the restored e-mail data on the liquid crystal display 418 via the LCD control unit 455.

Furthermore, the cell phone 400 can record (store) the received e-mail data in the storage unit 423 via the recording and reproduction unit 462.

The storage unit 423 can be formed from any rewritable storage medium. For example, the storage unit 423 may be formed from a semiconductor memory, such as a RAM or an internal flash memory, a hard disk, or a removable memory, such as a magnetic disk, a magnetooptical disk, an optical disk, a USB memory, or a memory card. However, it should be appreciated that another type of storage medium can be employed.

Still furthermore, in order to transmit image data in the data communication mode, the cell phone 400 generates image data through an image capturing operation performed by the CCD camera 416. The CCD camera 416 includes optical devices, such as a lens and an aperture, and a CCD serving as a photoelectric conversion element. The CCD camera 416 captures the image of a subject, converts the intensity of the received light into an electrical signal, and generates the image data of the subject image. The CCD camera 416 supplies the image data to the image encoder 453 via the camera I/F unit 454. The image encoder 453 compression-encodes the image data using a predetermined coding standard, such as MPEG2 or MPEG4, and converts the image data into encoded image data.

The cell phone 400 employs the above-described image encoding apparatus 51 as the image encoder 453 that performs such a process. Accordingly, like the image encoding apparatus 51, the image encoder 453 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Note that at the same time, the cell phone 400 analog-to-digital converts the sound collected by the microphone (MIC) 421 during the image capturing operation performed by the CCD camera 416 using the sound codec 459 and further performs an encoding process.

The cell phone 400 multiplexes, using the multiplexer/demultiplexer unit 457, the encoded image data supplied from the image encoder 453 with the digital sound data supplied from the sound codec 459 using a predetermined technique. The cell phone 400 performs a spread spectrum process on the resultant multiplexed data using the modulation and demodulation circuit unit 458 and performs a digital-to-analog conversion process and a frequency conversion process using the transmitting and receiving circuit unit 463. The cell phone 400 transmits a transmission signal obtained through the conversion processes to the base station (not shown) via the antenna 414. The transmission signal (the image data) transmitted to the base station is supplied to a communication partner via, for example, the network.

Note that if image data is not transmitted, the cell phone 400 can display the image data generated by the CCD camera 416 on the liquid crystal display 418 via the LCD control unit 455 without using the image encoder 453.

In addition, for example, in order to receive the data of a moving image file linked to, for example, a simplified Web page in the data communication mode, the cell phone 400 receives a signal transmitted from the base station via the antenna 414 using the transmitting and receiving circuit unit 463, amplifies the signal, and further performs a frequency conversion process and a digital-to-analog conversion process on the signal. The cell phone 400 performs an inverse spread spectrum process on the reception signal using the modulation and demodulation circuit unit 458 and restores the original multiplexed data. The cell phone 400 demultiplexes the multiplexed data into the encoded image data and sound data using the multiplexer/demultiplexer unit 457.

By decoding the encoded image data in the image decoder 456 using a decoding technique corresponding to a predetermined encoding standard, such as MPEG2 or MPEG4, the cell phone 400 can generate reproduction image data and displays the reproduction image data on the liquid crystal display 418 via the LCD control unit 455. Thus, for example, moving image data included in a moving image file linked to a simplified Web page can be displayed on the liquid crystal display 418.

The cell phone 400 employs the above-described image decoding apparatus 101 as the image decoder 456 that performs such a process. Accordingly, like the image decoding apparatus 101, the image decoder 456 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

At the same time, the cell phone 400 converts the digital sound data into an analog sound signal using the sound codec 459 and outputs the analog sound signal from the speaker 417. In this way, for example, the sound data included in the moving image file linked to the simplified Web page can be reproduced.

Note that as in the case of an e-mail, the cell phone 400 can record (store) the data linked to, for example, a simplified Web page in the storage unit 423 via the recording and reproduction unit 462.

In addition, the cell phone 400 can analyze a two-dimensional code obtained through an image capturing operation performed by the CCD camera 416 using the main control unit 450 and acquire the information recorded as the two-dimensional code.

Furthermore, the cell phone 400 can communicate with an external device using an infrared communication unit 481 and infrared light.

By using the image encoding apparatus 51 as the image encoder 453, the cell phone 400 can increase the coding efficiency for encoding, for example, the image data generated by the CCD camera 416 and generating encoded data. As a result, the cell phone 400 can provide encoded data (image data) with excellent coding efficiency to another apparatus.

In addition, by using the image decoding apparatus 101 as the image decoder 456, the cell phone 400 can generate a high-accuracy predicted image. As a result, the cell phone 400 can acquire a higher-resolution decoded image from a moving image file linked to a simplified Web page and display the higher-resolution decoded image.

Note that while the above description has been made with reference to the cell phone 400 using the CCD camera 416, an image sensor using a CMOS (Complementary Metal Oxide Semiconductor) (i.e., a CMOS image sensor) may be used in stead of the CCD camera 416. Even in such a case, as in the case of using the CCD camera 416, the cell phone 400 can capture the image of a subject and generate the image data of the image of the subject.

In addition, while the above description has been made with reference to the cell phone 400, the image encoding apparatus 51 and the image decoding apparatus 101 can be applied to any apparatus having an image capturing function and a communication function similar to those of the cell phone 400, such as a PDA (Personal Digital Assistant), a smart phone, a UMPC (Ultra Mobile Personal Computer), a netbook, or a laptop personal computer, as to the cell phone 400.

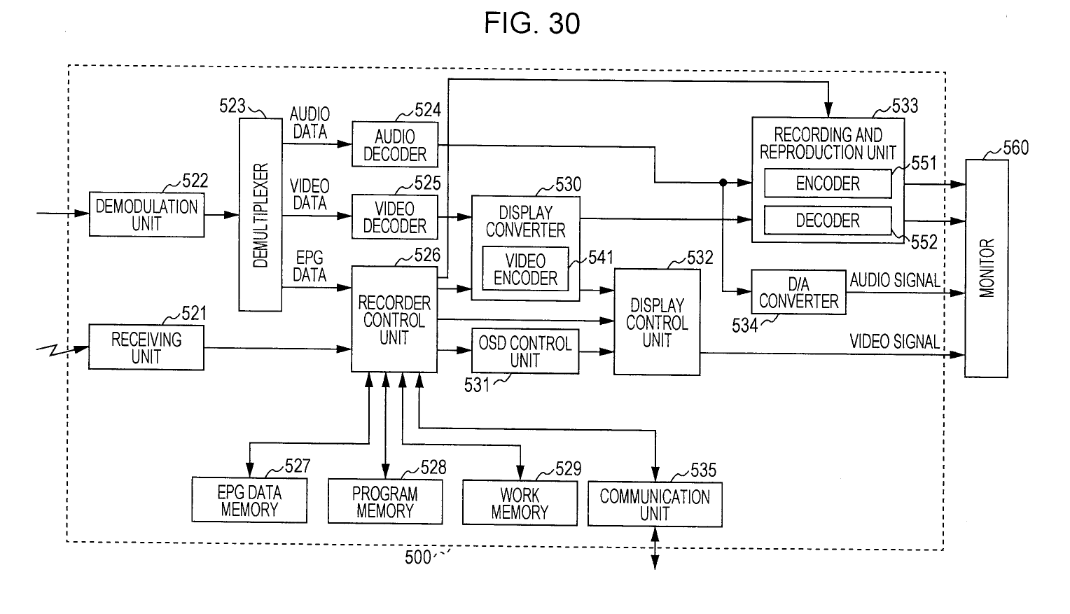

FIG. 30 is a block diagram of an example of the primary configuration of a hard disk recorder using the image encoding apparatus and the image decoding apparatus according to the present invention.

As shown in FIG. 30, a hard disk recorder (HDD recorder) 500 stores, in an internal hard disk, audio data and video data of a broadcast program included in a broadcast signal (a television program) emitted from, for example, a satellite or a terrestrial antenna and received by a tuner. Thereafter, the hard disk recorder 500 provides the stored data to a user at a timing instructed by the user.

The hard disk recorder 500 can extract audio data and video data from, for example, the broadcast signal, decode the data as needed, and store the data in the internal hard disk. In addition, the hard disk recorder 500 can acquire audio data and video data from another apparatus via, for example, a network, decode the data as needed, and store the data in the internal hard disk.

Furthermore, the hard disk recorder 500 can decode audio data and video data stored in, for example, the internal hard disk and supply the decoded audio data and video data to a monitor 560. Thus, the image can be displayed on the screen of the monitor 560. In addition, the hard disk recorder 500 can output the sound from a speaker of the monitor 560.

For example, the hard disk recorder 500 decodes audio data and video data extracted from the broadcast signal received via the tuner or audio data and video data acquired from another apparatus via a network. Thereafter, the hard disk recorder 500 supplies the decoded audio data and video data to the monitor 560, which displays the image of the video data on the screen of the monitor 560. In addition, the hard disk recorder 500 can output the sound from the speaker of the monitor 560.

It should be appreciated that the hard disk recorder 500 can perform other operations.

As shown in FIG. 30, the hard disk recorder 500 includes a receiving unit 521, a demodulation unit 522, a demultiplexer 523, an audio decoder 524, a video decoder 525, and a recorder control unit 526. The hard disk recorder 500 further includes an EPG data memory 527, a program memory 528, a work memory 529, a display converter 530, an OSD (On Screen Display) control unit 531, a display control unit 532, a recording and reproduction unit 533, a D/A converter 534, and a communication unit 535.

Furthermore, the display converter 530 includes a video encoder 541. The recording and reproduction unit 533 includes an encoder 551 and a decoder 552.

The receiving unit 521 receives an infrared signal transmitted from a remote controller (not shown) and converts the infrared signal into an electrical signal. Thereafter, the receiving unit 521 outputs the electrical signal to the recorder control unit 526. The recorder control unit 526 is formed from, for example, a microprocessor. The recorder control unit 526 performs a variety of processes in accordance with a program stored in the program memory 528. At that time, the recorder control unit 526 uses the work memory 529 as needed.

The communication unit 535 is connected to a network and performs a communication process with another apparatus connected thereto via the network. For example, the communication unit 535 is controlled by the recorder control unit 526 and communicates with a tuner (not shown). The communication unit 535 mainly outputs a channel selection control signal to the tuner.

The demodulation unit 522 demodulates the signal supplied from the tuner and outputs the demodulated signal to the demultiplexer 523. The demultiplexer 523 demultiplexes the data supplied from the demodulation unit 522 into audio data, video data, and EPG data and outputs these data items to the audio decoder 524, the video decoder 525, and the recorder control unit 526, respectively.

The audio decoder 524 decodes the input audio data using, for example, the MPEG standard and outputs the decoded audio data to the recording and reproduction unit 533. The video decoder 525 decodes the input video data using, for example, the MPEG standard and outputs the decoded video data to the display converter 530. The recorder control unit 526 supplies the input EPG data to the EPG data memory 527, which stores the EPG data.

The display converter 530 encodes the video data supplied from the video decoder 525 or the recorder control unit 526 into, for example, NTSC (National Television Standards Committee) video data using the video encoder 541 and outputs the encoded video data to the recording and reproduction unit 533. In addition, the display converter 530 converts the screen size for the video data supplied from the video decoder 525 or the recorder control unit 526 into a size corresponding to the size of the monitor 560. The display converter 530 further converts the video data having the converted screen size into NTSC video data using the video encoder 541 and converts the video data into an analog signal. Thereafter, the display converter 530 outputs the analog signal to the display control unit 532.

Under the control of the recorder control unit 526, the display control unit 532 overlays an OSD signal output from the OSD (On Screen Display) control unit 531 on a video signal input from the display converter 530 and outputs the overlaid signal to the monitor 560, which displays the image.

In addition, the audio data output from the audio decoder 524 is converted into an analog signal by the D/A converter 534 and is supplied to the monitor 560. The monitor 560 outputs the audio signal from a speaker incorporated therein.

The recording and reproduction unit 533 includes a hard disk serving as a storage medium for recording video data and audio data.

For example, the recording and reproduction unit 533 MPEG-encodes the audio data supplied from the audio decoder 524 using the encoder 551. In addition, the recording and reproduction unit 533 MPEG-encodes the video data supplied from the video encoder 541 of the display converter 530 using the encoder 551. The recording and reproduction unit 533 multiplexes the encoded audio data with the encoded video data using a multiplexer so as to synthesize the data. The recording and reproduction unit 533 amplifies the synthesized data by channel coding and writes the data into the hard disk via a recording head.

The recording and reproduction unit 533 reproduces the data recorded in the hard disk via a reproducing head, amplifies the data, and separates the data into audio data and video data using the demultiplexer. The recording and reproduction unit 533 MPEG-decodes the audio data and video data using the decoder 552. The recording and reproduction unit 533 D/A-converts the decoded audio data and outputs the converted audio data to the speaker of the monitor 560. In addition, the recording and reproduction unit 533 D/A-converts the decoded video data and outputs the converted video data to the display of the monitor 560.

The recorder control unit 526 reads the latest EPG data from the EPG data memory 527 in response to a user instruction indicated by an infrared signal emitted from the remote controller and received via the receiving unit 521. Thereafter, the recorder control unit 526 supplies the EPG data to the OSD control unit 531. The OSD control unit 531 generates image data corresponding to the input EPG data and outputs the image data to the display control unit 532. The display control unit 532 outputs the video data input from the OSD control unit 531 to the display of the monitor 560, which displays the video data. In this way, the EPG (electronic program guide) is displayed on the display of the monitor 560.

In addition, the hard disk recorder 500 can acquire a variety of types of data, such as video data, audio data, or EPG data, supplied from a different apparatus via a network, such as the Internet.

The communication unit 535 is controlled by the recorder control unit 526. The communication unit 535 acquires encoded data, such as video data, audio data, and EPG data, transmitted from a different apparatus via a network and supplies the encoded data to the recorder control unit 526. The recorder control unit 526 supplies, for example, the acquired encoded video data and audio data to the recording and reproduction unit 533, which stores the data in the hard disk. At that time, the recorder control unit 526 and the recording and reproduction unit 533 may re-encode the data as needed.

In addition, the recorder control unit 526 decodes the acquired encoded video data and audio data and supplies the resultant video data to the display converter 530. In the same manner for the video data supplied from the video decoder 525, the display converter 530 processes the video data supplied from the recorder control unit 526 and supplies the video data to the monitor 560 via the display control unit 532 so that the image is displayed.

In addition, at the same time as displaying the image, the recorder control unit 526 may supply the decoded audio data to the monitor 560 via the D/A converter 534 and output the sound from the speaker.

Furthermore, the recorder control unit 526 decodes the acquired encoded EPG data and supplies the decoded EPG data to the EPG data memory 527.

The above-described hard disk recorder 500 uses the image decoding apparatus 101 as each of the decoders included in the video decoder 525, the decoder 552, and the recorder control unit 526. Accordingly, like the image decoding apparatus 101, the decoder included in each of the video decoder 525, the decoder 552, and the recorder control unit 526 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Therefore, the hard disk recorder 500 can generate a high-accuracy predicted image. As a result, the hard disk recorder 500 can acquire a higher-resolution decoded image from encoded video data received via the tuner, encoded video data read from the hard disk of the recording and reproduction unit 533, or encoded video data acquired via the network and display the higher-resolution decoded image on the monitor 560.

In addition, the hard disk recorder 500 uses the image encoding apparatus 51 as the encoder 551. Accordingly, like the image encoding apparatus 51, the encoder 551 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Accordingly, for example, the hard disk recorder 500 can increase the coding efficiency for the encoded data stored in the hard disk. As a result, the hard disk recorder 500 can use the storage area of the hard disk more efficiently.

Note that while the above description has been made with reference to the hard disk recorder 500 that records video data and audio data in the hard disk, it should be appreciated that any recording medium can be employed. For example, like the above-described hard disk recorder 500, the image encoding apparatus 51 and the image decoding apparatus 101 can be applied even to a recorder that uses a recording medium other than a hard disk (e.g., a flash memory, an optical disk, or a video tape).

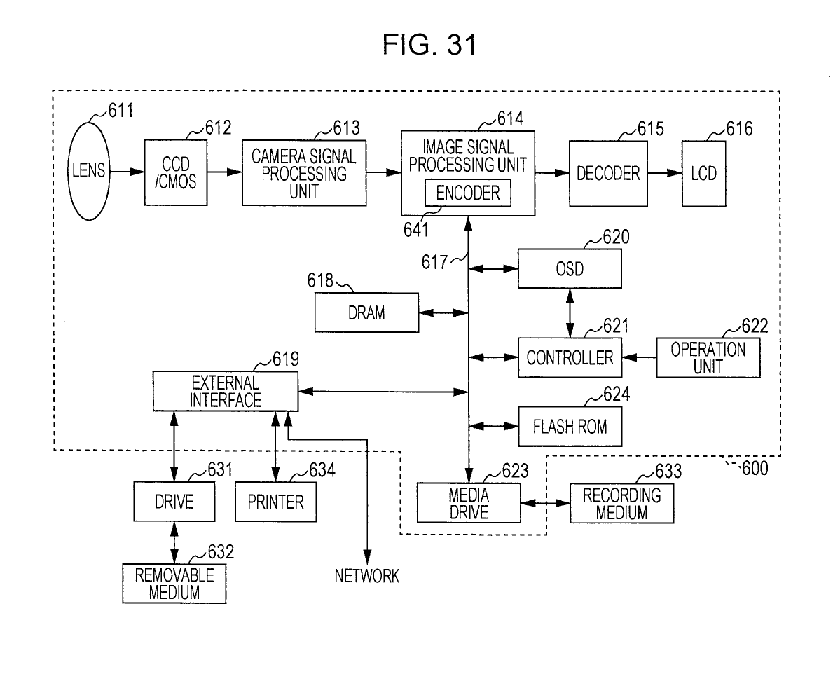

FIG. 31 is a block diagram of an example of the primary configuration of a camera using the image decoding apparatus and the image encoding apparatus according to the present invention.

A camera 600 shown in FIG. 31 captures the image of a subject and instructs an LCD 616 to display the image of the subject thereon or stores the image in a recording medium 633 in the form of image data.

A lens block 611 causes the light (i.e., the video of the subject) to be incident on a CCD/CMOS 612. The CCD/CMOS 612 is an image sensor using a CCD or a CMOS. The CCD/CMOS 612 converts the intensity of the received light into an electrical signal and supplies the electrical signal to a camera signal processing unit 613.

The camera signal processing unit 613 converts the electrical signal supplied from the CCD/CMOS 612 into Y, Cr, Cb color difference signals and supplies the color difference signals to an image signal processing unit 614. Under the control of a controller 621, the image signal processing unit 614 performs a predetermined image process on the image signal supplied from the camera signal processing unit 613 or encodes the image signal using an encoder 641 and, for example, the MPEG standard. The image signal processing unit 614 supplies encoded data generated by encoding the image signal to a decoder 615. In addition, the image signal processing unit 614 acquires display data generated by an on screen display (OSD) 620 and supplies the display data to the decoder 615.

In the above-described processing, the camera signal processing unit 613 uses a DRAM (Dynamic Random Access Memory) 618 connected thereto via a bus 617 as needed and stores, in the DRAM 618, encoded data obtained by encoding the image data as needed.

The decoder 615 decodes the encoded data supplied from the image signal processing unit 614 and supplies the resultant image data (the decoded image data) to the LCD 616. In addition, the decoder 615 supplies the display data supplied from the image signal processing unit 614 to the LCD 616. The LCD 616 combines an image of the decoded image data supplied from the decoder 615 with an image of the display data as needed and displays the combined image.

Under the control of the controller 621, the on screen display 620 outputs the display data, such as a menu screen including symbols, characters, or graphics and icons, to the image signal processing unit 614 via the bus 617.

The controller 621 performs a variety of types of processing on the basis of a signal indicating a user instruction input through the operation unit 622 and controls the image signal processing unit 614, the DRAM 618, an external interface 619, the on screen display 620, and a media drive 623 via the bus 617. A FLASH ROM 624 stores a program and data necessary for the controller 621 to perform the variety of types of processing.

For example, the controller 621 can encode the image data stored in the DRAM 618 and decode the encoded data stored in the DRAM 618 in stead of the image signal processing unit 614 and the decoder 615. At that time, the controller 621 may perform the encoding/decoding process using the encoding/decoding method employed by the image signal processing unit 614 and the decoder 615. Alternatively, the controller 621 may perform the encoding/decoding process using an encoding/decoding method different from that employed by the image signal processing unit 614 and the decoder 615.

In addition, for example, when instructed to print an image from the operation unit 622, the controller 621 reads the encoded data from the DRAM 618 and supplies, via the bus 617, the encoded data to a printer 634 connected to the external interface 619 via the external interface 619. Thus, the image data is printed.

Furthermore, for example, when instructed to record an image from the operation unit 622, the controller 621 reads the encoded data from the DRAM 618 and supplies, via the bus 617, the encoded data to the recording medium 633 mounted in the media drive 623. Thus, the image data is stored in the recording medium 633.

Examples of the recording medium 633 include readable and writable removable media, such as a magnetic disk, a magnetooptical disk, an optical disk, and a semiconductor memory. It should be appreciated that the recording medium 633 is of any removable medium type, such as a tape device, a disk, or a memory card. Alternatively, the recording medium 633 may be a non-contact IC card.

Alternatively, the media drive 623 may be integrated into the recording medium 633. For example, like an internal hard disk drive or an SSD (Solid State Drive), a non-removable storage medium can be used as the media drive 623 and the recording medium 633.

The external interface 619 is formed from, for example, a USB input/output terminal. When an image is printed, the external interface 619 is connected to the printer 634. In addition, a drive 631 is connected to the external interface 619 as needed. Thus, a removable medium 632, such as a magnetic disk, an optical disk, or a magnetooptical disk, is mounted as needed. A computer program read from the removable medium 632 is installed in the FLASH ROM 624 as needed.

Furthermore, the external interface 619 includes a network interface connected to a predetermined network, such as a LAN or the Internet. For example, in response to an instruction received from the operation unit 622, the controller 621 can read the encoded data from the DRAM 618 and supply the encoded data from the external interface 619 to another apparatus connected thereto via the network. In addition, the controller 621 can acquire, using the external interface 619, encoded data and image data supplied from another apparatus via the network and store the data in the DRAM 618 or supply the data to the image signal processing unit 614.

The above-described camera 600 uses the image decoding apparatus 101 as the decoder 615. Accordingly, like the image decoding apparatus 101, the decoder 615 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Therefore, the camera 600 can generate a high-accuracy predicted image. As a result, the camera 600 can acquire a higher-resolution decoded image from, for example, the image data generated by the CCD/CMOS 612, the encoded data of video data read from the DRAM 618 or the recording medium 633, or the encoded data of video data received via a network and display the decoded image on the LCD 616.

In addition, the camera 600 uses the image encoding apparatus 51 as the encoder 641. Accordingly, like the image encoding apparatus 51, the encoder 641 computes the weighting coefficient of implicit weighted prediction. Thus, even when POC is not based on equal intervals, an appropriate weighting coefficient can be computed without being affected by the POC. As a result, a decrease in coding efficiency can be prevented. In addition, since the weighting coefficient is independently computed for each of the template matching blocks, weighted prediction can be performed on the basis of the local characteristics of the image.

Accordingly, for example, the camera 600 can increase the coding efficiency for the encoded data stored in the hard disk. As a result, the camera 600 can use the storage area of the DRAM 618 and the storage area of the recording medium 633 more efficiently.

Note that the decoding technique employed by the image decoding apparatus 101 may be applied to the decoding process performed by the controller 621. Similarly, the encoding technique employed by the image encoding apparatus 51 may be applied to the encoding process performed by the controller 621.

In addition, the image data captured by the camera 600 may be a moving image or a still image.

It should be appreciated that the image encoding apparatus 51 and the image decoding apparatus 101 are applicable to apparatuses or systems other than the above-described apparatus.

### REFERENCE SIGNS LIST

51 image encoding apparatus
76 inter-template motion prediction/compensation unit
77 weighting coefficient computing unit
101 image decoding apparatus
123 inter-template motion prediction/compensation unit
124 weighting coefficient computing unit

1. An image processing apparatus comprising:
matching means for performing a matching process on a block of an image of a frame to be decoded using an inter-template matching method; and
predicting means for performing weighted prediction using pixel values of a template of the matching process performed by the matching means.

2. The image processing apparatus according to claim 1, wherein the image of the frame is a P picture and wherein the weighted prediction is implicit weighted prediction.

3. The image processing apparatus according to claim 2, wherein the predicting means performs the weighted prediction using a weighting coefficient computed from the pixel values of the template.

4. The image processing apparatus according to claim 3, further comprising:
computing means for computing the weighting coefficient using the following equation:
w₀=Ave(B′)/Ave(B)
where Ave(B) denotes an average value of the pixel values of the template, Ave(B′) denotes an average value of pixel values of a reference template that is a region of an image of a reference frame used as a reference for the matching and that has the highest correlation with the template, and w₀ denotes the weighting coefficient;
wherein the predicting means computes predicted pixel values of the block using the weighting coefficient w₀ and the following equation:
Pred(A)=w₀×Pix(A′)
where Pred(A) denotes the predicted pixel value of the block and Pix(A′) denotes a pixel value of the region of an image of the reference frame having the same positional relationship with the reference template as a positional relationship between the template and the block.

5. The image processing apparatus according to claim 4, wherein the computing means approximates the weighting coefficient w₀ to a value in the form of X/(2ⁿ).

6. The image processing apparatus according to claim 2, wherein the predicting means performs the weighted prediction using an offset computed from the pixel values of the template.

7. The image processing apparatus according to claim 6, further comprising:
computing means for computing the offset using the following equation:
d₀=Ave(B)−Ave(B′)
where Ave(B) denotes an average value of the pixel values of the template, Ave(B′) denotes an average value of pixel values of a reference template that is a region of an image of a reference frame used as a reference for the matching and that has the highest correlation with the template, and d₀ denotes the offset;
wherein the predicting means computes predicted pixel values of the block using the offset d₀ and the following equation:
Pred(A)=Pred(A′)+d₀
where Pred(A) denotes the predicted pixel value of the block and Pix(A′) denotes a predicted pixel value of the region of the image of the reference frame having the same positional relationship with the reference template as a positional relationship between the template and the block.

8. The image processing apparatus according to claim 2, wherein the predicting means extracts, from a header portion of a P picture representing the image of the frame, information indicting that implicit weighted prediction has been performed as the weighted prediction when encoding was performed on the block.

9. The image processing apparatus according to claim 1, further comprising:
computing means for computing first and second weighting coefficients used for the weighted prediction from the pixel values of the template;
wherein the computing means computes the first and second weighting coefficients using the following equations:
w₀=|Ave_tmplt_{—}L1−Ave_tmplt_Cur|, and
w₁=|Ave_tmplt_{—}L0−Ave_tmplt_Cur|

where Ave_tmplt_Cur denotes an average value of pixel values of the template, Ave_tmplt_L0 and Ave_tmplt_L1 denote average values of pixel values of a first reference plate and a second reference template that are regions of images of first and second reference frames used as a reference for the matching and that have the highest correlation with the template, respectively, and w₀ and w₁ denote the first and second weighting coefficients, respectively, and wherein the computing means normalizes the first weighting coefficient w₀ and the second weighting coefficient w₁ using the following equations:
w₀=w₀/(w₀+w₁), and
w₁=w₁/(w₀+w₁)
and wherein the predicting means computes predicted pixel values of the block using the normalized first weighting coefficient w₀ and second weighting coefficient w₁ and the following equation:
Pred_Cur=w₀×Pix_{—}L0+w₁×Pix_{—}L1
where Pred_Cur denotes the predicted pixel value of the block and Pix_L0 and Pix_L1 denote a pixel value of a region of an image of the first reference frame having the same positional relationship with the first reference template as a positional relationship between the template and the block and a pixel value of a region of an image of the second reference frame having the same positional relationship with the second reference template as the positional relationship between the template and the block, respectively.

10. The image processing apparatus according to claim 9, wherein the computing means approximates each of the first weighting coefficient w₀ and the second weighting coefficient w₁ to a value in the form of X/(2ⁿ).

11. An image processing method for use in an image processing apparatus, comprising the steps of:
performing a matching process on a block of an image of a frame to be decoded using an inter-template matching method; and
performing weighted prediction using pixel values of a template of the matching process.

12. An image processing apparatus comprising:
matching means for performing a matching process on a block of an image of a frame to be encoded using an inter-template matching method; and
predicting means for performing weighted prediction using pixel values of a template of the matching process performed by the matching means.

13. The image processing apparatus according to claim 12, wherein the image of the frame is a P picture and wherein the weighted prediction is implicit weighted prediction.

14. The image processing apparatus according to claim 13, further comprising:
inserting means for inserting information indicating that implicit weighted prediction has been performed as the weighted prediction into a header portion of the P picture representing the image of the frame.

15. An image processing method for use in an image processing apparatus, comprising the steps of:
performing a matching process on a block of an image of a frame to be encoded using an inter-template matching method; and
performing weighted prediction using pixel values of a template of the matching process.
